(19) United States
(12) Patent Application Publication
(10) Pub. No.: US 2024/0263272 A1
(43) Pub. Date: Aug. 8, 2024

(54) PROCESS FOR RECOVERING METAL VALUES FROM PROCESS LIQUORS

(71) Applicant: RESOURCE CONSERVATION AND RECYCLING CORPORATION PTY LTD, West Perth, Western Australia (AU)

(72) Inventors: Andrew NAPIER, West Perth, Western Australia (AU); Adam ROPER, West Perth, Western Australia (AU)

(21) Appl. No.: 18/020,902

(22) PCT Filed: Aug. 12, 2021
(86) PCT No.: PCT/AU2021/050886

§ 371 Date: Feb. 10, 2023

(30) Foreign Application Priority Data
Aug. 12, 2020 (AU) 2020902849

(51) Int. Cl. C22B 3/00; C22B 7/00; H01M 10/54

(52) U.S. Cl. CPC C22B 23/043; C22B 7/007; H01M 10/54

(57) ABSTRACT

Disclosed is a process for the selective separation and recovery of metal values from process liquors, in particular for the selective recovery of mixed metal sulfates, such as a mixed cobalt-nickel sulfate, from a metal sulfate process liquor.

### CROSS-REFERENCE TO RELATED APPLICATIONS

This application is the U.S. national phase of International Application No. PCT/AU2021/050886 filed Aug. 12, 2021, which designated the U.S. and claims priority to Australian Patent Application No. 2020902849 filed Aug. 12, 2020, the entire contents of each of which are hereby incorporated by reference.

### TECHNICAL FIELD

The present disclosure relates generally to processes for the selective separation and recovery of metal values from process liquors. More specifically, the present disclosure relates to processes for the selective recovery of mixed metal sulfates, such as a mixed cobalt-nickel sulfate, from a metal sulfate process liquor.

### BACKGROUND

There are currently a wide variety of processing methods for recovering one or more metal values from end-of-life lithium ion batteries, including both pyrometallurgical and hydrometallurgical processes. For example, following a suitable hydrometallurgical processing of lithium-batteries, one or more metal values of interest are dissolved and report to the process liquor, for example as sulfate soluble components in the process liquor where it is necessary to recover, separate and optionally purify the metal values for on-sale and/or recycling.

Current processes used to recover metal values utilize solvent extraction and/or precipitation methods to recover various metal values from sulfate process liquors. These processes often lack selectivity for various metals and/or utilize toxic and expensive reagents. Accordingly, there is a need for a recovery process which overcomes one or more of these disadvantages and/or provides the public with a useful alternative.

### SUMMARY

The present inventors have undertaken research and development into processes for selective separation and recovery of metal values from process liquors. In particular, the inventors have identified that cooling a metal sulfate process liquor results in the selective precipitation of a mixed cobalt-nickel sulfate, for example as a crystalline or semi-crystalline solid precipitate. Such selective precipitation using controlled cooling of the metal sulfate process liquor does not require expensive and toxic selective precipitation reagents currently used in industry thus reducing the harmful impact such materials have on the environment. The present disclosure described herein can also be scalable for industrial application, and finds use in the recovery of metal values from mixed metal oxide dust (MMD) obtained from recycled lithium-ion batteries. At least according to some examples and embodiments described herein, depending on the cooling temperature, one or more impurities present in the metal sulfate process liquor can be at least partially rejected from the mixed cobalt-nickel metal sulfate precipitate.

In one aspect, there is provided a process for recovering a mixed cobalt-nickel sulfate from a mixed metal sulfate process liquor, the process comprising the steps of:
a) cooling a mixed metal sulfate process liquor comprising cobalt and nickel from an initial temperature wherein the cobalt and nickel is dissolved therein to a temperature effective to precipitate out the a mixed cobalt-nickel sulfate from the process liquor; and
b) separating the mixed cobalt-nickel sulfate precipitate from the process liquor.

In some embodiments, the mixed metal sulfate process liquor is cooled to a temperature of between about 0.1° C. to about 50° C., or between about 1° C. to about 10° C., or less than about 10° C., for example about 5° C. In some embodiments, the initial temperature of the mixed metal sulfate process liquor is between about 30° C. up to the boiling point of the process liquor, for example between about 30° C. to about 100° C., or about 50° C. to about 100° C., e.g. between about 50° C. to about 70° C. In some embodiments, the temperature differential between the initial temperature and the cooled temperature of the mixed metal sulfate process liquor is between about 10° C. to about 100° C., for example between about 20° C. to about 80° C., for example between about 40° C. to about 60° C. In some embodiments, the initial temperature of the mixed metal sulfate process liquor is between about 50° C. up to the boiling point of the process liquor, and the cooled temperature of the mixed metal sulfate process liquor is between 1° C. to about 10° C.

The separated mixed cobalt-nickel sulfate precipitate can be further refined to further remove one or more metal impurities that may be present. In one embodiment, the process further comprises the steps of:
c) dissolving the separated mixed cobalt-nickel sulfate precipitate in an aqueous solution to form a mixed cobalt-nickel sulfate solution;
d) cooling the mixed cobalt-nickel sulfate solution from an initial temperature wherein the mixed cobalt-nickel sulfate is dissolved therein to a temperature effective to re-precipitate the mixed cobalt-nickel sulfate; and
e) separating the re-precipitated mixed cobalt-nickel sulfate from the solution.

The process is applicable across a variety of metal sulfate process liquors. In one embodiment, the metal sulfate process liquor is produced during the processing of recycled of lithium-ion batteries. In one embodiment, the metal sulfate process liquor is obtained via the reductive sulfuric acid leaching of a mixed metal material. In one embodiment, the metal sulfate process liquor is produced from refining of nickel and cobalt concentrates or intermediates such as processing of mixed nickel and/or cobalt hydroxide products or nickel and/or cobalt sulfide mineral concentrates, precipitates or matter.

In another aspect or embodiment, there is provided a process for preparing a mixed metal sulfate process liquor, comprising the steps of:
a1) heating a slurry comprising a mixed metal material, a reductant, and sulfuric acid to produce a leach slurry comprising the mixed metal sulfate process liquor; and
a2) washing the leach slurry with water and separating solids therefrom to provide the mixed metal sulfate process liquor.

In one embodiment, the slurry has a solids density of between about 20% w/w to about 60% w/w based on the total weight of the slurry. In one embodiment, the slurry is heated to a temperature from about 30° C. up to the boiling point of the slurry, for example between about 50° C. to about 70° C., or about 60° C. The slurry may be heated for a period of time of between about 2 h to about 24 h, for example about 4 h.

In one embodiment, the reductant may comprise sulfur dioxide or hydrogen peroxide. In one embodiment, the amount of sulfuric acid in the slurry is between about 100 kg/t to about 5000 kg/t based on the total weight of the mixed metal material, for example between about 800 kg/t to about 3000 kg/t based on the total weight of the mixed metal material.

In one embodiment, the mixed metal material is a mixed metal oxide dust (MMD). For example, the MMD may comprise lithium nickel manganese cobalt oxide (NMC), lithium cobalt oxide (LCO) or lithium nickel cobalt aluminium oxide (NCA), lithium manganese oxide (LMO), lithium ferro phosphate (LFP) or a mixture thereof.

In some embodiments, the separated liquor is further processed to remove one or more metal impurities and/or recover one or more additional metal values.

It will be appreciated that other aspects, embodiments and examples of the processes and materials are described herein.

### BRIEF DESCRIPTION OF FIGURES

Notwithstanding any other forms which may fall within the scope of the process described herein, specific embodiments will now be described, by way of example only, with reference to the accompanying figures in which:

FIG. 1: Process flow sheet depicting a process for recovering a mixed cobalt-nickel sulfate from a mixed metal sulfate process liquor via cooling precipitation.

FIG. 2: Process flow sheet depicting a process for recovering a mixed cobalt-nickel sulfate from a mixed metal sulfate process liquor via cooling precipitation incorporating an upstream reductive sulfuric acid leach step to generate the mixed metal sulfate process liquor.

FIG. 3: Process flow sheet depicting a process for recovering a mixed cobalt-nickel sulfate from a mixed metal sulfate process liquor via cooling precipitation incorporating the recycling of the separated liquor into the upstream reductive sulfuric acid leach step.

FIG. 4: Process flow sheet depicting a process for recovering a mixed cobalt-nickel sulfate from a mixed metal sulfate process liquor via cooling precipitation, further comprising a neutralization step prior to the cooling precipitation.

FIG. 5: Process flow sheet depicting a process for recovering a mixed cobalt-nickel sulfate from a mixed metal sulfate process liquor via cooling precipitation incorporating additional downstream processing for recovering of other values from the liquor stream.

FIG. 6: Process flow sheet depicting a process for recovering a mixed cobalt-nickel sulfate from a mixed metal sulfate process liquor via cooling precipitation incorporating additional downstream processing for recovering of other values from the liquor stream, with optional recycle of mixed metal sulfate and/or mixed metal sulfide to the reductive leach.

FIGS. 7 and 8: Precipitation profiles (% remaining in metal sulfate process liquor) of major metals following cooling precipitation at various temperatures. The metals profiled were cobalt (light blue), copper (yellow), nickel (orange), manganese (blue) and zinc (grey). The lower the % remaining in the metal sulfate process liquor, the higher the % amount of the metal in the obtained precipitate following cooling precipitation at a selected temperature.

FIG. 9: Precipitation profiles (% amount of the metal in the obtained precipitate) following cooling precipitation of a parent metal sulfate process liquor comprising a nickel to cobalt ratio (Ni:Co) of approximately 1:2 at various temperatures. The metals profiled were cobalt (blue), copper (orange), nickel (yellow), manganese (grey) and zinc (light blue).

FIG. 10: Precipitation profiles (% amount of the metal in the obtained precipitate) following cooling precipitation of a nickel doped metal sulfate process liquor having a nickel to cobalt ratio (Ni:Co) of approximately 1:1 (low Ni doped process liquor) at various temperatures. The metals profiled were cobalt (blue), copper (orange), nickel (yellow), manganese (grey) and zinc (light blue).

FIG. 11: Precipitation profiles (% amount of the metal in the obtained precipitate) following cooling precipitation of a nickel doped metal sulfate process liquor having a having a nickel to cobalt ratio (Ni:Co) of approximately 2:1 (high Ni doped process liquor) at various temperatures. The metals profiled were cobalt (blue), copper (orange), nickel (yellow), manganese (grey) and zinc (light blue).

FIG. 12: Mineralogical analysis (XRD) of precipitate obtained following the cooling precipitation of FIGS. 9 to 11. Intensities are offset for graphical purpose only: Parent PLS=−5000, Low Ni=25,000, High Ni=+55,000. (+) CoSO₄·H₂O, (*) CoSO₄.6H₂O, (A) NiSO₄.6H₂O.

### DETAILED DESCRIPTION

The present disclosure describes the following various non-limiting embodiments, which relates to investigations undertaken to identify processes for selective separation and recovery of metal values from process liquors. It was surprisingly found that cooling a metal sulfate process liquor (such as a pregnant leach solution obtained during the recycling of lithium-ion batteries) results in the selective precipitation of a mixed cobalt-nickel sulfate.

### General Terms

In the following description, reference is made to the accompanying drawings which form a part hereof, and which is shown, by way of illustration, several embodiments. It is understood that other embodiments may be utilized and structural changes may be made without departing from the scope of the present disclosure.

With regards to the definitions provided herein, unless stated otherwise, or implicit from context, the defined terms and phrases include the provided meanings. Unless explicitly stated otherwise, or apparent from context, the terms and phrases below do not exclude the meaning that the term or phrase has acquired by a person skilled in the relevant art. The definitions are provided to aid in describing particular embodiments, and are not intended to limit the claimed invention, because the scope of the invention is limited only by the claims. Furthermore, unless otherwise required by context, singular terms shall include pluralities and plural terms shall include the singular.

All publications discussed and/or referenced herein are incorporated herein in their entirety.

Any discussion of documents, acts, materials, devices, articles or the like which has been included in the present specification is solely for the purpose of providing a context for the present disclosure. It is not to be taken as an admission that any or all of these matters form part of the prior art base or were common general knowledge in the field relevant to the present disclosure as it existed before the priority date of each claim of this application.

Throughout this disclosure, unless specifically stated otherwise or the context requires otherwise, reference to a single step, composition of matter, group of steps or group of compositions of matter shall be taken to encompass one and a plurality (i.e., one or more) of those steps, compositions of matter, groups of steps or groups of compositions of matter. Thus, as used herein, the singular forms “a”, “an” and “the” include plural aspects unless the context clearly dictates otherwise. For example, reference to “a” includes a single as well as two or more; reference to “an” includes a single as well as two or more; reference to “the” includes a single as well as two or more and so forth.

Those skilled in the art will appreciate that the disclosure herein is susceptible to variations and modifications other than those specifically described. It is to be understood that the disclosure includes all such variations and modifications. The disclosure also includes all of the examples, steps, features, methods, compositions, coatings, processes, and coated substrates, referred to or indicated in this specification, individually or collectively, and any and all combinations or any two or more of said steps or features.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the present specification, including definitions, will control. In addition, the materials, methods, and examples are illustrative only and not intended to be limiting.

The term “and/or”, e.g., “X and/or Y” shall be understood to mean either “X and Y” or “X or Y” and shall be taken to provide explicit support for both meanings or for either meaning.

Unless otherwise indicated, the terms “first,” “second,” etc. are used herein merely as labels, and are not intended to impose ordinal, positional, or hierarchical requirements on the items to which these terms refer. Moreover, reference to a “second” item does not require or preclude the existence of lower-numbered item (e.g., a “first” item) and/or a higher-numbered item (e.g., a “third” item).

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example and without limitation, two of item A, one of item B, and ten of item C; four of item B and seven of item C; or some other suitable combination.

As used herein, the term “about”, unless stated to the contrary, typically refers to +/−10%, for example +/−5%, of the designated value.

The reference to “substantially free” generally refers to the absence of that compound or component in the material (e.g. absence of a particular impurity in the mixed metal sulfate) other than any trace amounts or impurities that may be present, for example this may be an amount by weight % in the total composition of less than about 1%, 0.1%, 0.01%, 0.001%, or 0.0001%.

It is to be appreciated that certain features that are, for clarity, described herein in the context of separate embodiments, may also be provided in combination in a single embodiment. Conversely, various features that are, for brevity, described in the context of a single embodiment, may also be provided separately or in any sub-combination.

Throughout the present specification, various aspects and components of the invention can be presented in a range format. The range format is included for convenience and should not be interpreted as an inflexible limitation on the scope of the invention. Accordingly, the description of a range should be considered to have specifically disclosed all the possible sub-ranges as well as individual numerical values within that range, unless specifically indicated. For example, description of a range such as from 1 to 5 should be considered to have specifically disclosed sub-ranges such as from 1 to 3, from 1 to 4, from 1 to 5, from 2 to 4, from 2 to 5, from 3 to 5 etc., as well as individual and partial numbers within the recited range, for example, 1, 2, 3, 4, 5, 5.5 and 6, unless where integers are required or implicit from context. This applies regardless of the breadth of the disclosed range. Where specific values are required, these will be indicated in the specification.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Each example of the present disclosure described herein is to be applied mutatis mutandis to each and every other example unless specifically stated otherwise. The present disclosure is not to be limited in scope by the specific examples described herein, which are intended for the purpose of exemplification only. Functionally equivalent products, compositions and methods are clearly within the scope of the disclosure as described herein.

### Specific Terms

As used herein, the term “mixed metal sulfate” includes any compound comprising at least two metals cations and the sulfate anion SO₄²⁻. By way of example, where the mixed metal sulfate process liquor is obtained during the leaching of recycled lithium-ion batteries, the mixed metal sulfate may comprise one or more metals that are present in lithium-ion batteries. As used herein, the term “metal” includes alkali metals, alkaline earth metals, transition metals, lanthanides, actinides and Group III elements. It will be appreciated that the metals in the mixed metal sulfate comprise nickel and cobalt. Other non-limiting examples of metals in the mixed metal sulfate can include aluminium, cobalt, copper, iron, lithium, magnesium, manganese, nickel, and zinc.

As used herein, the term “mixed metal material” includes any compound comprising at least two metals. By way of example, where the mixed metal material is obtained during the recycling of lithium-ion batteries, the mixed metal material may comprise one or more metals that are present in lithium-ion batteries, such as those present in the electrodes (e.g. cathode and anode materials). It will be appreciated that the metals in the mixed metal material comprise nickel and cobalt metal values. Other non-limiting examples of metals in the mixed metal material can include aluminium, cobalt, copper, iron, lithium, magnesium, manganese, nickel, sodium and zinc. The mixed metal material may be a mixed metal dust (MMD) (also referred to as a mixed metal oxide dust or black mass). In some embodiments, the MMD may be obtained during the recycling of lithium-ion batteries. The MMD may be a blend of one or more cathode and anode materials obtained from lithium-ion batteries. In some embodiments, the MMD comprises lithium nickel manganese cobalt oxide (NMC), lithium cobalt oxide (LCO) or lithium nickel cobalt aluminium oxide (NCA), lithium manganese oxide (LMO), lithium ferro phosphate (LFP) or a mixture thereof. The mixed metal material may comprise a plurality of particles.

As used herein, the term “mixed metal sulfate process liquor” will be understood to refer to an aqueous liquor comprising a mixed metal sulfate. For example, the mixed metal sulfate process liquor may comprise cobalt and nickel and one or more additional metals and/or impurities dissolved therein. The present process described herein is applicable across a variety of metal sulfate process liquors. In some embodiments, the metal sulfate process liquor may be a liquor produced by extracting one or more metal values from recycled lithium-ion batteries or other e-waste. Alternatively, in other embodiments, the metal sulfate process liquor may be a product of mining, drilling, processing, refining, dewatering, waste water treatment and excavations activities. For example, the metal sulfate process liquor may be a hydrometallurgical processing liquor produced by the sulfuric acid leaching of one or more mineral ores, concentrates, precipitated intermediates or matter. It will be appreciated that the concentration of the metal in the metal sulfate process liquor can vary depending on its source and that the metal sulfate process liquor may undergo one or more processes to increase the metal content thereof to a concentration suitable to undergo the process as described herein.

As used herein, the term “mixed cobalt-nickel sulfate” will be understood to refer to a compound comprising at least cobalt and nickel cation and the sulfate anion SO₄²⁻. The mixed cobalt-nickel sulfate may contain one or more impurities. As used herein, the term “impurities” refers to a metal or non-metal value other than cobalt and nickel, that is present in the mixed cobalt-nickel sulfate. If present, the type and amount of impurity in the mixed cobalt-nickel sulfate may depend on the mixed metal sulfate process liquor. Typical impurities present in the mixed cobalt-nickel sulfate may include aluminium, magnesium, manganese, iron, copper and zinc. It will be appreciated that the mixed cobalt-nickel sulfate is not a mere mixture of cobalt sulfate and nickel sulfate, but rather it is a single compound, as described herein.

As used herein, the term “precipitate” or “precipitation” refers to the formation of an insoluble solid from a solution. The precipitate may form as a result of a chemical reaction (e.g. via the addition of an appropriate precipitant to the solution). Alternatively, a precipitate may form if a material dissolved in a liquor exceeds its solubility limit, such as by changing the liquids temperature. Depending on the nature of the precipitation, the precipitate may be an amorphous precipitate, or comprise one or more crystals e.g. crystalline precipitate. In some embodiments, the precipitation may also induce crystallisation.

As used herein, the term “crystal”, “crystalline solid”, “crystalline compound”, or “crystalline precipitate” refers a solid material whose constituents (such as atoms, molecules, or ions) are arranged with a degree of order to form a crystal lattice. The degree of crystallinity can vary (e.g. single crystal, polycrystalline (e.g. comprise two or more crystal phases) or semi-crystalline) and can be measured by suitable techniques, such as x-ray diffraction (XRD). The term “crystallisation” refers to the process of forming a crystalline material, such as by cooling a solution comprising one or materials dissolved therein (e.g. cobalt/nickel) to form a crystalline precipitate. As used herein, the term “amorphous precipitate” refers to a compound having no degree of crystallinity (e.g. non-crystalline).

A reference to ‘g/kg’ or ‘kg/t’ throughout the specification refers to the mass of a substance per kilogram or tonne, respectively, of the total weight of mixed metal material. A reference to “g/L” throughout the specification refers to the mass of a substance per litre of the total volume of the process liquor. A reference to “% w/w” throughout the specification refers to the percentage amount of a substance in a composition on a weight basis.

The term “boiling point” is used to refer to the temperature at which a liquid or slurry boils under the particular pressure to which it is being subjected (e.g. ambient pressure or autoclave). It will be appreciated that the boiling point may also vary according to the various solutes in the liquid or slurry and their concentration.

Process for Recovering Mixed Cobalt-Nickel Sulfate from Process Liquors

Mixed cobalt-nickel sulfate may be recovered from various mixed metal sulfate process liquors, for example liquors obtained during the recycling of lithium-ion batteries.

Current processes used to recover metal values utilize solvent extraction and/or precipitation methods which can lack selectivity for various metals and/or utilize toxic and expensive reagents. Advantageously, the inventors have devised a process that selectively precipitates (e.g. crystallises) mixed cobalt-nickel sulfate from mixed metal sulfate process liquors without the need for addition of chemical precipitants and/or solvent extraction reagents.

The process comprises cooling a mixed metal sulfate process liquor comprising cobalt and nickel from an initial temperature wherein the cobalt and nickel is dissolved therein to a temperature effective to precipitate (e.g. crystallise) out the mixed cobalt-nickel sulfate from the process liquor. The inventors have surprisingly identified that selectively cooling the mixed metal sulfate process liquor to low temperatures results in the selective precipitation of a mixed cobalt-nickel sulfate while substantially rejecting the other metals also present in the metal sulfate process liquor. In contrast to other techniques used to selectively precipitate metal values from process liquors, this process resulted in the selective precipitation of cobalt and nickel as a mixed sulfate as opposed to solely discrete sulfate compounds (e.g. cobalt sulfate and nickel sulfate).

### Cooling Precipitation

The mixed metal sulfate process liquor is cooled to precipitate a mixed cobalt-nickel sulfate out of the process liquor. In an embodiment, the cooling precipitation step is a crystallisation and/or re-crystallisation step. The mixed metal sulfate process liquor has an initial temperature and is cooled to a lower temperature (i.e. a cooled temperature). It will be understood that the initial temperature is higher (e.g. hotter) than the cooled temperature.

In some embodiments, the mixed metal sulfate process liquor is cooled to a temperature effective to recover at least about 5, 10, 20, 30, 40, 50, 60, 70, 80, 90%, or 95% of cobalt from the process liquor, for example between about 30% to about 90%, or between about 60% to about 80% of cobalt. In some embodiments, the mixed metal sulfate process liquor is cooled to a temperature effective to recover at least about 5, 10, 20, 30, 40, 50, 60, 70, 80, 90%, or 95% of nickel from the process liquor, for example between about 30% to about 90%, or between about 10% to about 60%, or between about 20% to 50% of nickel.

In some embodiments, the mixed metal sulfate process liquor is cooled to a temperature of between about 0.1° C. to about 50° C. In some embodiments, the mixed metal sulfate process liquor is cooled to a temperature of less than about 50, 45, 40, 35, 30, 25, 20, 15, 10, 9, 8, 7, 6, 5, 4, 3, 2, 1 or 0.1° C. Combinations of these values are also possible, for example between about 1° C. to about 10° C., about 2° C. to about 8° C., or about 3° C. to about 7° C. In some embodiments, the mixed metal sulfate process liquor is cooled to a temperature of less than about 10° C., for example about 5° C. or less. In some embodiments, the inventors have identified that cooling the mixed metal sulfate process liquor to a temperature of about 5° C. or less precipitates cobalt and nickel out of the mixed metal sulfate process liquor solution with a high degree of selectivity over other metal impurities present in the process liquor.

In some embodiments, the initial temperature of the mixed metal sulfate process liquor prior to cooling is from 30° C. up to the boiling point of the process liquor, for example from 50° C. up to the boiling point of the process liquor. In some embodiments, the initial temperature of the mixed metal sulfate process liquor prior to cooling is at least about 30, 40, 50, 60, 70, 80, 90, 100, 120 or 150° C., for example between about 30° C. to about 150° C., about 30° C. to about 100° C., or about 50° C. to about 100° C., for example about 60° C. However, it will be appreciated that other initial temperatures are also applicable, provided a temperature differential is created between the initial and cooled temperature of the mixed metal sulfate process liquor.

In one embodiment, the mixed metal sulfate process liquor is cooled from an initial temperature (e.g. heated temperature) down to a cooled temperature (e.g. precipitation temperature). In some embodiments, the mixed metal sulfate process liquor is cooled from an initial temperature (e.g. from 30° C. up to the boiling point of the process liquor) down to a cooled temperature of less than about 50, 45, 40, 35, 30, 25, 20, 15, 10, 5, or 1° C., provided the initial temperature is higher (e.g. hotter) than the cooled temperature. In some embodiments, the temperature differential between the initial temperature and the cooled temperature of the mixed metal sulfate process liquor is at least about 10, 20, 30, 40, 50, 60, 70, 80, 90 or 100° C. In some embodiments, the temperature differential between the initial temperature and the cooled temperature of the mixed metal sulfate process liquor may be between about 10° C. to about 100° C., about 20° C. to about 100° C., about 30° C. to about 100° C., about 40° C. to about 100° C., about 20° C. to about 80° C., about 30° C. to about 70° C., about 40° C. to about 60° C. In some embodiments, the present inventors have identified that a large temperature differential between the initial temperature and cooled temperature of the mixed metal sulfate process liquor maximises the bite (e.g. the efficiency) of precipitation of the cobalt and nickel from the process liquor, and in some embodiments the precipitation of the mixed sulfate. In one embodiment, the temperature differential between the initial temperature and the cooled temperature of the mixed metal sulfate process liquor is between about 40° C. to about 60° C. In at least some embodiments comprising a high temperature differential, further advantages can be provided such as the selective rejection of one or more metal impurities present in the metal sulfate process liquor from the mixed cobalt-nickel sulfate precipitate.

The rate of cooling may also influence the selective precipitation. In some embodiments, the mixed metal sulfate process liquor is cooled from the initial temperature at a rate of at least about −0.1, −0.5, −1, −2, −4, −6, −8, −10, −12, −14, −16, −18, −20, −25, −30, −35, −40, −45, −50, −65, −70, −75, −80, −95 or −100° C./min. Combinations of these cooling rates are also possible, for example between about −1° C./min to about −100° C./min, or −1° C./min to about −50° C./min. It will be appreciated that the cooling rate may also depend on the volume of mixed metal sulfate process liquor being cooled, and other cooling rates are also envisaged.

The cooling precipitation may be performed in any suitable apparatus that is configured to cool the liquor housed therein. For example, the apparatus may comprise a) a vessel configured to house the mixed metal sulfate process liquor, b) a fluid circulation means for circulating a heat transfer fluid along a wall of the vessel; and c) a heat exchange device capable of heating and/or cooling a circulating heat transfer fluid to create a temperature differential between the wall of the vessel and the mixed metal sulfate process liquor effective to precipitate (e.g. crystallise) out a mixed cobalt-nickel sulfate from the process liquor. Suitable apparatus' may include a heat exchanger, immersed coils or cooling jacket or a specifically designed cooling precipitator/crystalliser vessel which is associated with a vessel housing the process liquor, to cool the fluid to the desired temperature to precipitate (e.g. crystallise) out the mixed cobalt-nickel sulfate.

### Mixed Metal Sulfate Process Liquor

The mixed metal sulfate process liquor comprises cobalt and nickel dissolved therein. The present inventors have identified that selectively cooling the mixed metal sulfate process liquor to low temperatures lead to the selective precipitation of a mixed cobalt-nickel sulfate.

In some embodiments, the concentration of cobalt in the mixed metal sulfate process liquor may be provided in an amount which is at or near the solubility limit of cobalt in the sulfate process liquor. In some embodiments, the concentration of cobalt in the mixed metal sulfate process liquor may be at least about 5, 10, 20, 30, 40, 50, 60, or 70 g/L based on the total volume of the process liquor. In some embodiments, concentration of cobalt in the mixed metal sulfate process liquor may be less than about 70, 60, 50, 40, 30, 20, 10, or 5 g/L based on the total volume of the process liquor.

Combinations of these concentration (e.g. g/L) values to form various ranges are also possible, for example, in some embodiments the concentration of cobalt in the mixed metal sulfate process liquor may be between about 5 g/L to about 70 g/L, about 10 g/L to about 70 g/L, about 20 g/L to about 70 g/L, about 30 g/L to about 70 g/L, about 40 g/L to about 70 g/L, about 50 g/L to about 70 g/L, about 60 g/L to about 70 g/L, about 5 g/L to about 60 g/L, about 10 g/L to about 60 g/L, about 20 g/L to about 60 g/L, about 5 g/L to about 50 g/L, about 10 g/L to about 50 g/L, about 20 g/L to about 50 g/L, about 5 g/L to about 40 g/L, about 10 g/L to about 40 g/L, about 20 g/L to about 40 g/L, about 5 g/L to about 30 g/L, about 10 g/L to about 30 g/L, about 5 g/L to about 20 g/L, about 10 g/L to about 20 g/L, about 30 g/L to about 60 g/L, about 30 g/L to about 50 g/L, or about 40 g/L to about 60 g/L based on the total volume of the process liquor.

In some embodiments, the concentration of nickel in the mixed metal sulfate process liquor may be provided in an amount which is at or near the solubility limit of nickel in the sulfate process liquor. In some embodiments, the concentration of nickel in the mixed metal sulfate process liquor may be at least about 5, 10, 20, 30, 40, 50, 60, or 70 g/L based on the total volume of the process liquor. In some embodiments, the concentration of nickel in the mixed metal sulfate process liquor may be less than about 70, 60, 50, 40, 30, 20, 10, or 5 g/L based on the total volume of the process liquor. Combinations of these concentration (e.g. g/L) values to form various ranges are also possible, for example, in some embodiments the concentration of nickel in the mixed metal sulfate process liquor may be between about 5 g/L to about 70 g/L, about 10 g/L to about 70 g/L, about 20 g/L to about 70 g/L, about 30 g/L to about 70 g/L, about 40 g/L to about 70 g/L, about 50 g/L to about 70 g/L, about 60 g/L to about 70 g/L, about 5 g/L to about 60 g/L, about 10 g/L to about 60 g/L, about 20 g/L to about 60 g/L, about 5 g/L to about 50 g/L, about 10 g/L to about 50 g/L, about 20 g/L to about 50 g/L, about 5 g/L to about 40 g/L, about 10 g/L to about 40 g/L, about 20 g/L to about 40 g/L, about 5 g/L to about 30 g/L, about 10 g/L to about 30 g/L, about 5 g/L to about 20 g/L, about 10 g/L to about 20 g/L, about 30 g/L to about 60 g/L, about 30 g/L to about 50 g/L, or about 40 g/L to about 60 g/L based on the total volume of the process liquor.

In some embodiments, one or more additional metal or non-metal values other than cobalt and nickel (e.g. impurities) may be present in the mixed metal sulfate process liquor in an amount of less than about 50, 40, 30, 20, 10, 1, 0.1, or 0.01 g/L based on the total volume of the process liquor. Examples of additional metal or non-metal values that may be present include aluminium, arsenic, calcium, cadmium, chromium, copper, iron, potassium, lithium, magnesium, manganese, sodium, phosphorous, silicon, zinc, or fluorine.

In one embodiment, prior to cooling precipitation, the concentration of cobalt and nickel in the mixed metal sulfate process liquor may be increased by evaporating the process liquor and/or removing one or more impurities (e.g. by precipitation).

The mixed metal sulfate process liquor may have a free sulfuric acid concentration. In some embodiments, the mixed metal sulfate process liquor has a free sulfuric acid concentration of at least about 10, 20, 50, 70, 90, 100, 120, 150, 170, 200, 250, 300, 350, 400, or 500 g/L based on the total volume of the process liquor. In some embodiments, the mixed metal sulfate process liquor has a free sulfuric acid concentration of less than about 500, 400, 350, 300, 250, 200, 170, 150, 120, 100, 90, 70, 50, 20, or 10 g/L based on the total volume of the process liquor. Combinations of these concentration (e.g. g/L) values to form various ranges are also possible, for example, in some embodiments the mixed metal sulfate process liquor has a free sulfuric acid concentration of between about 1 g/L to about 500 g/L, about 10 g/L to about 500 g/L, about 50 g/L to about 400 g/L, about 100 g/L to about 300 g/L, about 50 g/L to about 300 g/L, about 150 g/L to about 250 g/L, or about 1 g/L to about 300 g/L.

In some embodiments, increasing the free acidity of the process liquor may increase the precipitation and recovery of the mixed cobalt-nickel sulfate from the process liquor. Where the process liquor is a pregnant process solution obtained following a reductive sulfuric acid leach of mixed metal material (e.g. mixed metal oxide dust (MMD) from lithium-ion batteries), the free sulfuric acid concentration may be controlled by altering one or more conditions of said reductive sulfuric acid leach.

Alternatively or additionally, the mixed metal sulfate process liquor may undergo one or more processes to increase or decrease the free sulfuric acid concentration to a target concentration prior to selective cooling precipitation. For example, an amount of sulfuric acid may be added to the mixed metal sulfate process liquor prior to selective cooling precipitation. This in turn may lower the pH (e.g. more acidic pH).

Alternatively or additionally, the metal sulfate process liquor may undergo a primary neutralisation step to neutralise some of the free sulfuric acid content in the process liquor to reduce the free sulfuric acid concentration to a desired level prior to undergoing cooling precipitation. In doing so, the pH of the metal sulfate process liquor may be increased (e.g. more alkaline pH). In some embodiments, if required, limestone (calcium carbonate), lime or sodium hydroxide (or another suitable neutralising agent) may be added to the liquor to neutralise some of the free sulfuric acid and/or increase the pH (e.g. more alkaline pH) of the metal sulfate process liquor. The amount of neutralising agent added may be between about 2 g/L to about 200 g/L, based on the total volume of process liquor, however it will be appreciated that other concentrations are also suitable and can vary depending on the target pH of the mixed metal sulfate process liquor.

In some embodiments, the pH of the mixed metal sulfate process liquor may be an acidic pH. In some embodiments, the pH of the mixed metal sulfate process liquor may be between about pH −1 to about pH 5. The pH of the mixed metal sulfate process liquor may be less than about pH 5, 4.5, 4, 3.5, 3, 2.5, 2, 1.5, 1, 0.5, 0.2, 0.1, 0, −0.1, −0.2, −0.5 or −1. The pH of the mixed metal sulfate process liquor may be at least −1, −0.5, −0.2, −0.1, 0, 0.1, 0.2, 0.5, 1, 1.5, 2, 2.5, 3, 3.5, 4, 4.5, or 5. Combinations of these pH values are also possible, for example, the pH of the metal sulfate process liquor may be between about pH 1 to about pH 5, about pH 1 to about pH 4, or about pH 1 to about pH 3.

In one embodiment, the pH of the mixed metal sulfate process liquor may be about pH −1, −0.5, −0.2, −0.1, 0, 0.1, 0.2, 0.5, 1, 1.2, 1.3, 1.4, 1.5, 1.6, 1.7, 2.0, 2.2, 2.4, 2.6, 2.8, or 3.0. In one embodiment, the pH of the mixed metal sulfate process liquor may be between about pH −1 to about pH 3, about pH −0.2 to about pH 3, about pH −0.1 to about pH 3, about pH 0 to about pH 3, about pH 0.1 to about pH 3, about pH 0.2 about pH 3, about pH 0.5 to about pH 3, about pH 1 to about pH 3, about pH 1.2 to about pH 3, about pH 1.5 to about pH 3, or about pH 2 to about pH 3. Other combinations within the range of about pH −0.5 to about pH 3 are also possible.

If required, following pre-neutralisation, any precipitated impurities (including by-products such as gypsum or hydroxides produced during any pre-neutralisation step) may be separated from the process liquor prior to cooling precipitation by conventional separation techniques including, but not limited to, filtration, solid liquid separation, gravity separation, centrifugation, decantation and so forth.

### Mixed Cobalt-Nickel Sulfate Precipitate

The mixed metal sulfate process liquor is cooled to a temperature effective to precipitate out a mixed cobalt-nickel sulfate from the process liquor whilst one or more impurities remain dissolved in the liquor.

The cooled mixed metal sulfate process liquor has a solids density (e.g. precipitation yield) owing to the precipitation of the mixed cobalt-nickel sulfate. The cooled mixed metal sulfate process liquor may have a solids density of at least about 1, 2, 5, 10, 15, 20, 25, 30, 40 or 50% w/w based on the total w/w of the cooled process liquor. The cooled mixed metal sulfate process liquor may have a solids density of less than about 50, 40, 30, 25, 20, 15, 10, 5, 2, or 1% w/w based on the total w/w of the cooled process liquor. Combinations of these solid density values are also possible, for example, the cooled mixed metal sulfate process liquor may have a solids density of between about 1% w/w to about 40% w/w, or between 5% w/w to about 20% w/w based on the total w/w of the process liquor.

The mixed cobalt-nickel sulfate can be separated from the cooled process liquor by conventional separation techniques including, but not limited to, filtration, solid liquid separation, gravity separation, centrifugation, decantation and so forth.

The mixed cobalt-nickel sulfate precipitate comprises a compound having at least cobalt and nickel and the sulfate anion SO₄²⁻. The mixed cobalt-nickel sulfate may also contain one or more impurities. It will be appreciated that in one embodiment the mixed cobalt-nickel sulfate is a crystalline, semi-crystalline or amorphous compound. By way of example only, the mixed cobalt-nickel sulfate may comprise a compound having the formula (Co/Ni)SO₄ although other structures are also possible depending on the crystallinity of (if any) and/or presence of other components in the mixed cobalt-nickel sulfate precipitate. It will be appreciated that, in some embodiments, the mixed cobalt-nickel sulfate precipitate (crystalline or amorphous) is not merely a mixture of cobalt sulfate and nickel sulfate compounds. For example, the mixed cobalt-nickel sulfate precipitate or solid compound material may be obtained as a single or semi-crystalline compound and not merely a mixture of cobalt sulfate and nickel sulfate. In one embodiment, the crystalline precipitate is (Co/Ni)SO₄.6H₂O. Alternatively, the mixed cobalt-nickel sulfate may be amorphous. Surprisingly, this mixed phase sulfate is selectively precipitated out of the process liquor upon cooling whilst rejecting other impurities which remained dissolved in the process liquor.

In some embodiments, the mixed cobalt-nickel sulfate precipitate comprises at least about 1, 5, 10, 15, 20, 25, 30, 35, 40, 45, 50, 55 or 60% w/w cobalt. In some embodiments, the mixed cobalt-nickel sulfate precipitate comprises less than about 60, 55, 50, 45, 40, 35, 30, 25, 20, 15, 10, or 5% w/w cobalt. Combinations of these w/w % values are also possible, for example the mixed cobalt-nickel sulfate precipitate may comprise between about 1% w/w to about 60% w/w cobalt, between about 5% w/w to about 60% w/w cobalt, for example between about 10% w/w to about 60% w/w cobalt.

In some embodiments, the mixed cobalt-nickel sulfate precipitate comprises at least about 1, 2, 3, 4, 5, 6, 7, 8, 10, 15, 20, 30, 40, 45, 50, 55 or 60% w/w nickel. In some embodiments, the mixed cobalt-nickel sulfate precipitate comprises less than about 60, 55, 50, 45, 40, 30, 20, 15, 10, 8, 7, 6, 5, 4, 3, or 2% w/w nickel. Combinations of these w/w % values are also possible, for example the mixed cobalt-nickel sulfate precipitate may comprise between about 1% w/w to about 60% w/w nickel, 10% w/w to about 60% w/w nickel, for example between about 1% w/w to about 10% w/w nickel.

In some embodiments, the mixed cobalt-nickel sulfate precipitate comprises between about 5% w/w to about 50% w/w cobalt and between about 1% w/w to about 20% w/w nickel. In other embodiments, the mixed cobalt-nickel sulfate precipitate comprises between about 10% w/w to about 60% w/w cobalt and between about 1% w/w to about 60% w/w nickel. It will be appreciated that other w/w % values of cobalt and nickel present in the precipitate can be achieved using the selective cooling precipitation process described herein. The present inventors have identified that, in some embodiments, cooler precipitation temperatures can increase the w/w % of cobalt and/or nickel present in the precipitate.

In some embodiments, the recovery of cobalt from the mixed metal sulfate process liquor in the mixed cobalt-nickel sulfate precipitate is at least about 5, 10, 20, 30, 40, 50, 60, 70, 80, 90, or 95% based on the total amount of cobalt in the process liquor (also referred to as the % precipitation). In some embodiments, the recovery of cobalt from the mixed metal sulfate process liquor in the mixed cobalt-nickel sulfate precipitate is between about 5% to about 90%, about 10% to about 90%, about 20% to about 90%, about 30% to about 90%, about 40% to about 90%, about 50% to about 90%, about 60% to about 90%, or about 70% to about 90%, about 80% to about 90%, about 5% to about 80%, about 10% to about 80%, about 20% to about 80%, about 30% to about 80%, about 40% to about 80%, about 50% to about 80%, about 60% to about 80%, or about 70% to about 80%, about 20% to about 70%, about 30% to about 70%, about 40% to about 70%, about 50% to about 80%, about 50% to about 70%, about 50% to about 60%, about 60% to about 80%, about 60% to about 70%, or about 70% to about 80% based on the total amount of cobalt in the process liquor.

In some embodiments, the recovery of nickel from the mixed metal sulfate process liquor in the mixed cobalt-nickel sulfate precipitate is at least about 5, 10, 20, 30, 40, 50, 60, 70, 80, 90 or 95% based on the total amount of nickel in the process liquor. In some embodiments, the recovery of nickel from the mixed metal sulfate process liquor in the mixed cobalt-nickel sulfate precipitate is between about 10% to about 60% based on the total amount of nickel in the process liquor, for example between about 20% to 50%.

In some embodiments, the combined weighted average of recovery of cobalt and nickel from the mixed metal sulfate process liquor in the mixed cobalt-nickel sulfate precipitate is at least about 40, 50, 60, 70, 80, 90, or 95% based on the total amount of cobalt and nickel in the process liquor. In some embodiments, the combined weighted average of recovery of cobalt and nickel from the mixed metal sulfate process liquor in the mixed cobalt-nickel sulfate precipitate is between about 5% to about 90%, about 10% to about 90%, about 20% to about 90%, about 30% to about 90%, about 40% to about 90%, about 50% to about 90%, about 60% to about 90%, or about 70% to about 90%, about 80% to about 90%, about 5% to about 80%, about 10% to about 80%, about 20% to about 80%, about 30% to about 80%, about 40% to about 80%, about 50% to about 80%, about 60% to about 80%, or about 70% to about 80%, about 20% to about 70%, about 30% to about 70%, about 40% to about 70%, about 50% to about 80%, about 50% to about 70%, about 50% to about 60%, about 60% to about 80%, about 60% to about 70%, or about 70% to about 80% based on the total amount of cobalt and nickel in the process liquor.

One or more impurities (e.g. metal or non-metal values) in the mixed cobalt-nickel sulfate precipitate may be present in less than about 20, 15, 10, 9, 8, 7, 6, 5, 4, 3, 2, 1, 0.1, 0.01, or 0.001% w/w based on total weight of the precipitate. Impurities may be selected from one or more of aluminium, arsenic, calcium, cadmium, chromium, copper, iron, potassium, lithium, magnesium, manganese, sodium, phosphorous, silicon, zinc, or fluorine. In one example, the impurity comprises manganese.

In some embodiments, the mixed cobalt-nickel sulfate precipitate is substantially free of one or more of aluminium, arsenic cadmium, calcium, chromium, lithium, potassium, phosphorous, sodium, and silicon impurities. For example, in some embodiments, the mixed cobalt-nickel precipitate may comprise less than about 1%, 0.1%, 0.01%, 0.001%, or 0.0001% w/w of one or more of aluminium, arsenic cadmium, calcium, chromium, lithium, potassium, phosphorous, sodium, and silicon based on the total weight of the precipitate. In one embodiment, the mixed cobalt-nickel sulfate precipitate comprises less than about 0.1% w/w of one or more of aluminium, arsenic cadmium, calcium, chromium, lithium, potassium, phosphorous, sodium, and silicon impurities. In at least some embodiments, further advantages are provided by cooling the process liquor to low temperatures (e.g. less than 10° C.) such as substantially reducing the presence of one or more impurities in the precipitate, for example aluminium, arsenic cadmium, calcium, chromium, lithium, potassium, phosphorous, sodium, and/or silicon impurities.

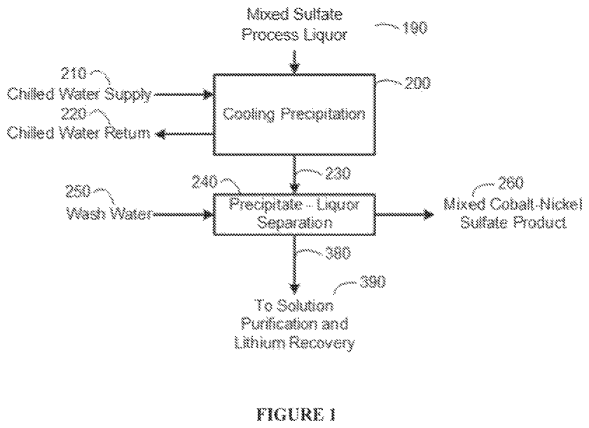

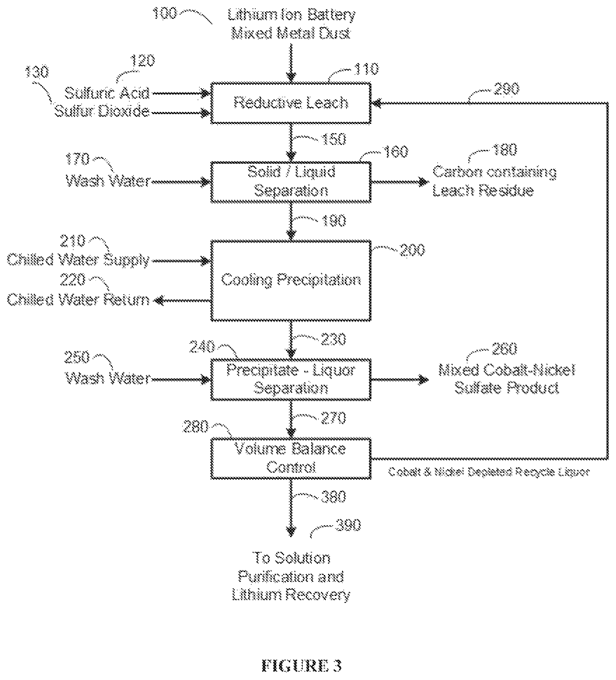

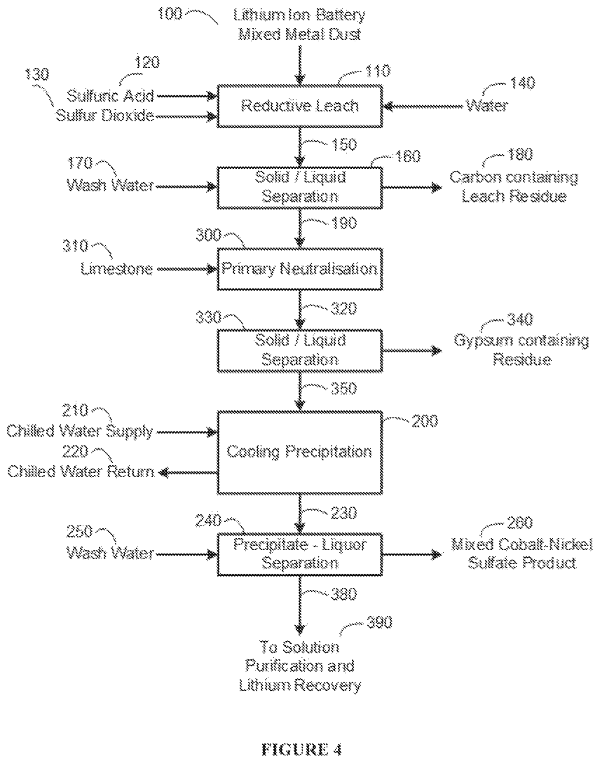

As a non-limiting example, an embodiment of the cooling precipitation is provided in FIG. 1, where a mixed metal sulfate process liquor (190) is forwarded to cooling precipitation unit, where chilled water (210) is supplied through a heat exchange device, such as a heat exchanger, immersed coils, or cooling jacket associated with the precipitator/crystalliser vessel, to cool the process liquor (e.g. to 5° C.), inducing selective precipitation of mixed cobalt-nickel sulfate (260). Chilled water return (220) can return to a separate refrigeration plant (not shown) to be re-cooled. While shown as “chilled water”, other cooling media such as, brines, refrigerants, or other heat transfer fluids may also be used. Multiple stages of cooling may also be used to enhance thermal efficiency. The cooled slurry comprising the precipitate (230) undergoes a solid liquid separation (240) to obtained the mixed cobalt-nickel sulfate precipitate (260), with optional wash water (250) added to remove soluble components entrained with the precipitate. The cobalt and nickel depleted liquor (380) is then optionally passed to downstream processes (390) for purification and recovery of additional metal values (e.g. lithium), or recycled for re-use upstream in an optional reductive leach step to generate the metal sulfate process liquor (see for example FIG. 3). The mixed cobalt-nickel precipitate (260) may be further processed or purified (e.g. via re-precipitation). As a non-limiting example, referring to FIG. 4, a primary neutralisation step (300) may be performed on the process liquor (190) prior to cooling precipitation by adding limestone (310) to the process liquor to produce a partially neutralised process liquor (320). Any gypsum containing residue (340) that may be produced during the primary neutralisation may be removed from the partially neutralised process liquor (320) by solid liquid separation (330) prior to cooling crystallisation (200).

Separated mixed cobalt-nickel sulfate precipitate may be transported for sale, for example as a wet filter cake which may be optionally dried to remove excess moisture. Alternatively, the mixed cobalt-nickel sulfate precipitate may be further processed and refined.

In one embodiment, the process further comprises seeding the mixed metal sulfate process liquor with a mixed cobalt-nickel sulfate crystal to facilitate precipitation of the mixed cobalt-nickel sulfate. Such seeding may improve crystal growth or the aid in the rejection of impurities present in the mixed metal sulfate leach liquor from reporting to the mixed cobalt-nickel sulfate.

### Further Precipitation and Refining

In some embodiments, the mixed cobalt-nickel sulfate precipitate can be further processed to further reduce the impurities present in the precipitate (such as manganese). For example, by redissolving the precipitate in water and repeating the cooling precipitation (e.g. crystallisation) process described herein. This particular refinement step comprises a) dissolving the mixed cobalt-nickel sulfate precipitate in an aqueous solution to form a mixed cobalt-nickel sulfate solution; b) cooling the mixed cobalt-nickel sulfate solution from an initial temperature wherein the mixed cobalt-nickel is dissolved therein to a temperature effective to re-precipitate the mixed cobalt-nickel sulfate; and c) separating the re-precipitated mixed cobalt-nickel sulfate from the solution. In an embodiment, the cooling precipitation step is a crystallisation and/or re-crystallisation step.

Advantageously, the re-precipitation step may lead to an order of magnitude reduction in manganese impurity. For example, up to 70% of manganese present in the precipitate was rejected by re-precipitation, whilst minimal to no rejection of cobalt and nickel indicating good recovery of the mixed cobalt-nickel sulfate.

In some embodiments, the mixed cobalt-nickel precipitate may be dissolved in water at a temperature of least about 50, 60, 70, 80, 90 or 100° C., for example between 50° C. to about 70° C., for example about 60° C. In some embodiments, the dissolved cobalt-nickel sulfate solution may then be cooled to a temperature of less than about 50, 45, 40, 35, 30, 25, 20, 15, 10, 5, or 1° C., preferably less than about 10° C., for example about 5° C. In some embodiments, the temperature differential between the initial temperature and the cooled temperature of the mixed cobalt-metal sulfate solution is at least about 10, 20, 30, 40, 50, 60, 70, 80, 90 or 99° C. In some embodiments, the temperature differential between the initial temperature and the cooled temperature of the mixed cobalt-nickel sulfate solution may be between about 10° C. to about 90° C., about 20° C. to about 80° C., about 30° C. to about 70° C., about 40° C. to about 60° C. Embodiments described herein in relation to the cooling precipitation of the process liquor also apply for the re-precipitation of the mixed cobalt-metal sulfate precipitate.

In some embodiments, one or more impurities present in the metal sulfate process liquor can be at least partially rejected from the mixed cobalt-nickel metal sulfate precipitate by the re-precipitation step. In some embodiments, the re-precipitated mixed cobalt-nickel sulfate precipitate is substantially free of one or more of aluminium, arsenic, cadmium, calcium, chromium, lithium, potassium, phosphorous, sodium, and silicon impurities. For example, in some embodiments, the re-precipitated mixed cobalt-nickel precipitate may comprise less than about 1%, 0.1%, 0.01%, 0.001%, or 0.0001% w/w of one or more of aluminium, arsenic, cadmium, calcium, chromium, lithium, potassium, phosphorous, sodium, and silicon based on the total weight of the precipitate.

The re-precipitated mixed cobalt-nickel sulfate can be separated from the solution by conventional separation techniques including, but not limited to, filtration, solid liquid separation, gravity separation, centrifugation, decantation and so forth.

### Reductive Sulfuric Acid Leach of Mixed Metal Materials

The cooling precipitation (e.g. crystallisation) process is applicable across a variety of metal sulfate process liquors. In one embodiment, the metal sulfate process liquor is produced during the recycling of lithium-ion batteries. In one embodiment, the metal sulfate process liquor is obtained via the reductive sulfuric acid leaching of a mixed metal material (e.g. a mixed metal dust MMD).

Accordingly, in one aspect or embodiment, the mixed metal sulfate process liquor is provided by the steps: a1) of heating a slurry comprising a mixed metal material, a reductant, and sulfuric acid to produce a leach slurry comprising the mixed metal sulfate process liquor; and a2) washing the leach slurry with water and separating solids therefrom to provide the mixed metal sulfate process liquor, wherein the mixed metal sulfate process liquor comprises soluble cobalt and nickel.

It will be appreciated that the mixed metal material comprises at least cobalt and nickel values. In one embodiment, the mixed metal material may be a mixed metal dust (MMD) (e.g. a mixed metal oxide dust). In some embodiments, the mixed metal material (e.g. MMD) may be obtained during the recycling of lithium-ion batteries. In one embodiment, the MMD is obtained from lithium-ion batteries. The mixed metal material (e.g. MMD) may be a blend of one or more cathode and anode materials obtained from lithium-ion batteries. In some embodiments, the MMD comprises lithium nickel manganese cobalt oxide (NMC), lithium cobalt oxide (LCO) or lithium nickel cobalt aluminium oxide (NCA), lithium manganese oxide (LMO), lithium ferro phosphate (LFP) or a mixture thereof.

In some embodiments, the mixed metal material may comprise at least about 2, 5, 10, 15, 20, 25, 30, 35, 40, 45, 50, or 60% w/w cobalt. In some embodiments, the mixed metal material comprises less than about 60, 50, 45, 40, 35, 30, 25, 20, 15, 10, 5, or 2% w/w cobalt. Combinations of these w/w % values are also possible, for example the mixed metal material may comprise between about 5% w/w to between about 40% w/w cobalt, for example between about 10% w/w to about 30% w/w cobalt.

In some embodiments, the mixed metal material may comprise at least about 1, 2, 3, 4, 5, 6, 7, 8, 10, 15, 20, 30 or 40% w/w nickel. In some embodiments, the mixed metal material may comprises less than about 40, 30, 20, 15, 10, 8, 7, 6, 5, 4, 3, or 2% w/w nickel. Combinations of these w/w % values are also possible, for example the mixed metal material may comprise between about 1% w/w to between about 20% w/w nickel, for example between about 1% w/w to about 10% w/w nickel. In some embodiments, the mixed metal material comprises between about 10% w/w to about 30% w/w cobalt and between about 1% w/w to about 10% w/w nickel.

One or more additional metal or non-metal values other than cobalt and nickel (e.g. impurities) may be present in the mixed metal material in less than about 15, 10, 9, 8, 7, 6, 5, 4, 3, 2, 1, 0.1, 0.01, or 0.001% w/w based on total weight of the material. The additional metals may be selected from one or more of aluminium, arsenic, calcium, cadmium, chromium, copper, iron, potassium, lithium, magnesium, manganese, sodium, phosphorous, carbon, silicon, zinc, or fluorine.

The mixed metal material (e.g. MMD) may comprise one or more particles (e.g. a blend of particles), wherein at least some of the particles comprise cobalt and nickel. Other particles may be present in the mixed metal material which comprise or more additional metal or non-metal values other than cobalt or nickel (e.g. impurities).

The term “particle” (also referred to as “particulate”) refers to the form of discrete solid units. The units may take the form of flakes, fibres, agglomerates, granules, powders, spheres, pulverized materials or the like, as well as combinations thereof. The particles may have any desired shape including, but not limited to, cubic, rod like, polyhedral, spherical or semi-spherical, rounded or semi-rounded, angular, irregular, and so forth.

In some embodiments, the mixed metal material may have an average particle size. The average particle size is taken to be the cross-sectional diameter across a particle. For non-spherical particles, the particle size is taken to be the distance corresponding to the longest cross-section dimension across the particle. In some embodiments, the mixed metal material comprises particles having an average particle size of between about 1 μm to about 1,000 μm, for example between about 5 μm to about 500 μm, e.g. between about 10 μm to about 200 μm. The mixed metal material may have a particle size distribution (PSD), wherein 90% of the particles (P₉₀) have a particle size of less than about 120 μm, wherein 80% of the particles (P₈₀) have a particle size of less than about 60 μm, wherein 50% of the particles (P₈₀) have a particle size of less than about 25 μm, wherein 20% of the particles (P₂₀) have a particle size of less than about 10 μm, or wherein 10% of the particles (P₂₀) have a particle size of less than about 5 μm. The average particles size and/or PSD can be measured by any conventional method, including laser diffraction, electron microscopy, dynamic light scattering, optical microscopy or size exclusion methods (such as graduated mesh filters or screens).

In some embodiments, the reductive sulfuric acid leach is effective to extract at least 80, 85, 90, 92, 95, 96, 97, 98 or 99% of the cobalt and/or nickel present in the mixed metal material into the mixed metal sulfate process liquor.

In one embodiment, the mixed metal material is not subject to a binder decrepitation roast prior to reductive leaching.

In some embodiments, the slurry is heated to a temperature sufficient to achieve a particular level of extraction of cobalt and nickel values from the mixed metal material. In some embodiments, the slurry is heated to a temperature from about 30° C. up to the boiling point of the slurry, for example from about 50° C. up to the boiling point of the slurry. It will be appreciated by those skilled in the art that, other things being equal, the higher the temperature, the shorter the reaction time to achieve the desired level of extraction.

In some embodiments, the slurry is heated to a temperature of at least 30, 40, 50, 60, 70, 80, 90, 100, 120, or 150° C. The slurry may be heated under ambient pressure or in an autoclave (e.g. under pressure) to obtain higher temperatures. In some embodiments, the slurry is heated to a temperature of less than about 150, 120, 100, 90, 80, 70, 60, 50, 40, or 30° C. Combinations of these temperature values are also possible, for example the slurry may be heated to between about 50° C. to about 70° C. In one embodiment, the slurry is heated to a temperature of about 60° C.

In some embodiments, the slurry may be heated for a period of time sufficient to achieve a particular level of extraction of cobalt and nickel values. In some embodiments, the slurry is heated for a period of time of between about 2 h to 24 h, for example between about 2 h to 12 h, e.g. about 4 h.

The reductive sulfuric acid leach may be carried out in either a batch mode or a continuous mode. The particular choice of operation will depend upon a residence time necessary to extract the desired amount of cobalt and nickel values from the mixed metal material and the volume of the mixed metal material available for treatment.

In some embodiments, the slurry has a solids density of at least about 10, 15, 20, 25, 30, 35, 40, 45, 50, 55 or 60% w/w based on the total weight of the slurry. In some embodiments, the slurry has a solids density of less than about 60, 55, 50, 45, 40, 35, 30, 25, 20, 15, or 10% w/w based on the total weight of the slurry. Combinations of these w/w % are also possible, for example the slurry has a solids density of between about 20% w/w to about 60% w/w, or about 40% w/w to about 50% w/w based on the total weight of the slurry.

In some embodiments, the reductant is added in an amount sufficient to achieve a particular level of extraction of cobalt and nickel values from the mixed metal material. In some embodiments, the reductant is provided in the slurry in an amount effective to provide an oxidation reduction potential (ORP) of between about 100 mV to about 900 mV (verses a Pt—Ag/AgCl electrode), for example between about 300 mV to about 700 mV, e.g. between about 400 mV to about 600 mV. In some embodiments, the reductant is provided in the slurry in an amount effective to provide an oxidation reduction potential (ORP) of about 100, 200, 300, 400, 500, 600, 700, 800, or 900 mV. Combinations of these ORP values are also possible.

In some embodiments, the ORP may be less than about 500 mV. In some embodiments, further advantages may be provided by lowering the ORP of the leach slurry (e.g. an ORP of less than 500 mV), such as reduced extraction of copper, aluminium and/or zinc from the mixed metal material into the process liquor, which in turn reduces the overall presence of these metals as impurities in the mixed metal sulfate process liquor.

In some embodiments, the reductant comprises sulfur dioxide, sulfur, sulfides, sulfites, bisulfites, alcohols, sugars or hydrogen peroxide. In one embodiment, the reductant comprises sulfur dioxide. It will be appreciated that where the reductant is sulfur dioxide (SO₂), this will often be introduced as a gas.

The sulfuric acid is present in the slurry in an amount sufficient to achieve a particular level of extraction of cobalt and nickel values from the mixed metal material. In some embodiments, the sulfuric acid is present in an amount effective to provide a cobalt and/or nickel concentration in the mixed metal sulfate process liquor in an amount which is at or near the solubility limit of cobalt and/or nickel in the sulfate process liquor.

In some embodiments, the sulfuric acid is present in an amount effective to provide a cobalt concentration in the mixed metal sulfate process liquor of between about 5 g/L to about 70 g/L, about 10 g/L to about 70 g/L, about 20 g/L to about 70 g/L, about 30 g/L to about 70 g/L, about 40 g/L to about 70 g/L, about 50 g/L to about 70 g/L, about 60 g/L to about 70 g/L, about 5 g/L to about 60 g/L, about 10 g/L to about 60 g/L, about 20 g/L to about 60 g/L, about 5 g/L to about 50 g/L, about 10 g/L to about 50 g/L, about 20 g/L to about 50 g/L, about 5 g/L to about 40 g/L, about 10 g/L to about 40 g/L, about 20 g/L to about 40 g/L, about 5 g/L to about 30 g/L, about 10 g/L to about 30 g/L, about 5 g/L to about 20 g/L, about 10 g/L to about 20 g/L, about 30 g/L to about 60 g/L, about 30 g/L to about 50 g/L, or about 40 g/L to about 60 g/L based on the total volume of the process liquor, and/or a nickel concentration in the mixed metal sulfate process liquor of between about 5 g/L to about 70 g/L, about 10 g/L to about 70 g/L, about 20 g/L to about 70 g/L, about 30 g/L to about 70 g/L, about 40 g/L to about 70 g/L, about 50 g/L to about 70 g/L, about 60 g/L to about 70 g/L, about 5 g/L to about 60 g/L, about 10 g/L to about 60 g/L, about 20 g/L to about 60 g/L, about 5 g/L to about 50 g/L, about 10 g/L to about 50 g/L, about 20 g/L to about 50 g/L, about 5 g/L to about 40 g/L, about 10 g/L to about 40 g/L, about 20 g/L to about 40 g/L, about 5 g/L to about 30 g/L, about 10 g/L to about 30 g/L, about 5 g/L to about 20 g/L, about 10 g/L to about 20 g/L, about 30 g/L to about 60 g/L, about 30 g/L to about 50 g/L, or about 40 g/L to about 60 g/L based on the total volume of the process liquor. In one embodiment, the sulfuric acid may be added to the slurry in a stoichiometric amount or a stoichiometric excess based on the amount of cobalt and/or nickel in the mixed metal material.

In some embodiments, the amount of sulfuric acid in the slurry is at least about 100, 200, 500, 800, 1000, 1500, 2000, 3000, 4000, or 5000 kg/t based on the total weight of the mixed metal material. In some embodiments, the amount of sulfuric acid in the slurry is less than about 5000, 4000, 3000, 2000, 1500, 1000, 800, 500, 200, or 100 kg/t based on the total weight of the mixed metal material. Combinations of these kg/t values are possible, for example, the amount of sulfuric acid in the slurry may be between about 100 kg/t to about 5000 kg/t based on the total weight of the mixed metal material, for example between about 800 kg/t to about 3000 kg/t based on the total weight of the mixed metal material.

In some embodiments, the leach slurry has a free sulfuric acid concentration. In some embodiments, the leach slurry has a free sulfuric acid concentration of at least about 10, 20, 50, 70, 90, 100, 120, 150, 170, 200, 250, 300, 350, 400, or 500 g/L based on the total volume of the slurry. In some embodiments, the leach slurry process liquor has a free sulfuric acid concentration of less than about 500, 400, 350, 300, 250, 200, 170, 150, 120, 100, 90, 70, 50, 20, or 10 g/L based on the total volume of the slurry. Combinations of these concentration (e.g. g/L) values to form various ranges are also possible, for example, in some embodiments the leach slurry has a free sulfuric acid concentration of between about 20 g/L to about 400 g/L, or about 30 g/L to about 300 g/L.

The metal sulfate process liquor may be separated from any leach residue by conventional separation techniques including, but not limited to, filtration, solid liquid separation, gravity separation, centrifugation, and decantation.

The metal sulfate process liquor may undergo a primary neutralisation step as described herein.

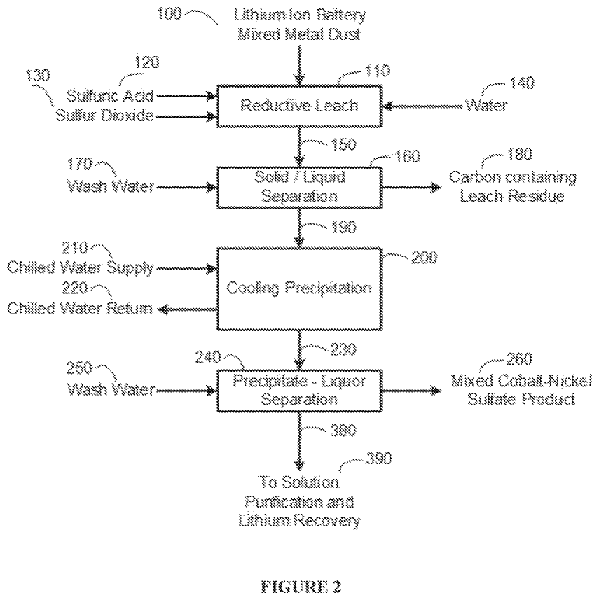

As a non-limiting example, an embodiment of the reductive sulfuric acid leach to generate the mixed metal sulfate process liquor is provided in FIG. 2, where a mixed metal dust (100), reclaimed from lithium-ion batteries is reductively leached (110), with sulfuric acid (120) and a suitable reductant, such as sulfur dioxide (130), with water (140) optionally added if necessary to maintain the fluidity of the leach slurry. The process solution temperature may be about 60° C., due to a combination of the enthalpy of dilution of sulfuric acid and the enthalpy of the dissolution of the mixed metal dust. The leach slurry (150) undergoes a solid liquid separation (160), with the optional addition of wash water (170), to liberate any soluble components entrained with the leach residue (180), which is reused or disposed of in the appropriate manner, resulting in the metal sulfate process liquor (190), which is forward on to cooling precipitation (200) as described herein.

### Processing of the Separated Process Liquor

Following cooling precipitation, the mixed cobalt-nickel sulfate precipitate is separated from the process liquor. Where a mixed cobalt-nickel sulfate is obtained during the cooling precipitation process, it will be appreciated that the separated process liquor comprises less nickel and cobalt (in g/L based on the total volume of the process liquor) compared to the process liquor prior to cooling precipitation. In some embodiments, some residual cobalt and nickel remain dissolved in the separated process liquor.

In some embodiments, the concentration of cobalt remaining in the separated process liquor after cooling precipitation may be less than about 50, 40, 30, 20, 10, 5, or 1 g/L based on the total volume of the separated process liquor. Combinations of these g/L values to form various ranges are also possible, for example, in some embodiments the concentration of cobalt remaining in the separated process liquor after cooling precipitation may be about between 1 g/L to about 40 g/L, about 5 g/L to about 30 g/L, or about 10 g/L to about 20 g/L based on the total volume of the separated process liquor.

In some embodiments, the concentration of nickel remaining in the separated process liquor after cooling precipitation may be less than about 50, 40, 30, 20, 10, 5, or 1 g/L based on the total volume of the separated process liquor. Combinations of these g/L values to form various ranges are also possible, for example, in some embodiments the concentration of nickel remaining in the separated process liquor after cooling precipitation may be about between 1 g/L to about 40 g/L, about 5 g/L to about 30 g/L, or about 10 g/L to about 20 g/L based on the total volume of the separated process liquor.

In some embodiments, at least part of the separated process liquor may be then recycled back into the reductive leach step, which may provide further advantages such as increasing the concentration of cobalt, nickel and/or sulfate in the mixed metal sulfate process liquor. For example, referring to an embodiment of the process in FIG. 3, the separated process liquor (e.g. the cobalt and nickel depleted liquor) (270) from precipitate-liquor separation (240) can be split in a volume balance control step (280), to produce a cobalt and nickel depleted recycle liquor stream (290), which is added to the reductive leach (110).

Alternatively or additionally, the process further comprises depleting the separated process liquor of one or more impurities. In some embodiments, depleting the separated process liquor of one or more impurities may comprise selective precipitation, ion exchange, solvent extraction, or adsorption, optionally in combination with a complexing agent.

In some embodiments, the separated process liquor may be further processed to remove one or more additional impurities and/or recover other metal values. In one embodiment, the separated liquor may be neutralised to remove free sulfuric acid and/or precipitate one or more impurities, such as iron. Suitable neutralising agents include lime or limestone. In one embodiment, the separated process liquor may be treated with sulfide (e.g. sodium hydrosulfide) to recover soluble cobalt, copper, zinc and/or nickel present in the process liquor as a mixed sulfide precipitate (e.g. a mixed cobalt-nickel sulfide precipitate or a mixed cobalt-zinc-copper-nickel sulfide precipitate). The mixed sulfide precipitate may be separated from the process liquor to provide a base metal free liquor (e.g. a cobalt and nickel depleted liquor). Additionally, in one embodiment, the cobalt and nickel depleted liquor is further treated to remove one or more impurities and/or values.

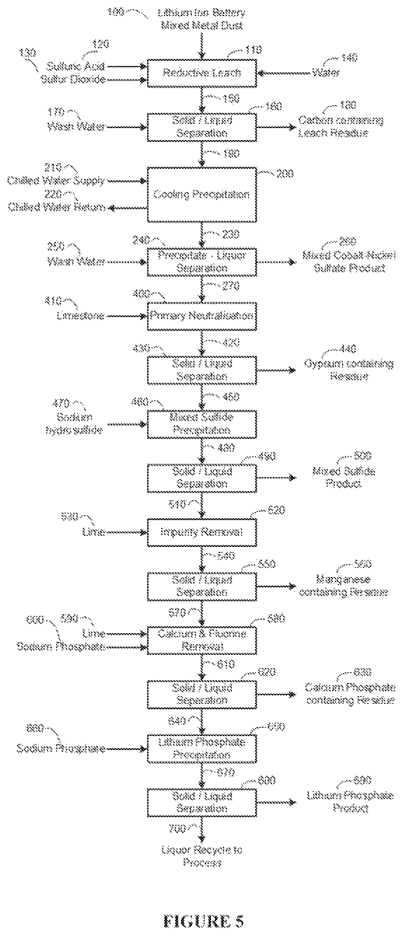

As a non-limiting example, referring to the embodiment of the process in FIG. 5, the separated process liquor (270) can pass to primary neutralisation (400). Limestone (410) can be added to neutralise free sulfuric acid and precipitate iron. The resultant neutralised slurry (420) can then proceed to solid liquid separation (430), to produce a gypsum containing residue (440).

The neutralised solution (450) then can undergo mixed sulfide precipitation (460), using for example sodium hydrosulfide (470). This step scavenges any residual cobalt and nickel left remaining in the liquor following cooling precipitation, along with precipitating copper and zinc. The resultant slurry (480) can then proceed to solid liquid separation (490), to produce a mixed cobalt-nickel-copper-zinc sulfide product (500). Such products are typically able to be refined in existing cobalt and nickel refineries.

The base metal depleted liquor (510) (e.g. substantially free of cobalt, nickel, copper and zinc) may then undergo an impurity removal step (520), where lime (530), is added to precipitate manganese and other impurities such as aluminium and silicon. The resultant slurry (540), is subject to solid liquid separation (550), to produce a manganese containing residue (560).

The manganese depleted liquor (570), may be further treated to remove calcium and fluorine (580), using lime (590), and sodium phosphate (600). The resultant slurry (610), is subject to solid liquid separation (620), to produce a calcium phosphate containing residue (630). For example, the calcium content in the manganese depleted liquor (570) may be decreased to less than 25 ppm. In some embodiments, calcium is removed from the manganese depleted liquor (570) by adding potassium carbonate or potassium phosphate to the liquor to produce calcium precipitates comprising calcium carbonate or apatite. In other embodiments, calcium may be removed from the manganese depleted liquor (570) by adding alkali metal phosphates, such as sodium phosphate, to the liquor to produce calcium precipitates comprising calcium phosphate containing residue (e.g. apatite and/or fluorapatite). The term ‘apatite’ as used herein refers to one or more calcium phosphate compounds of general formula Ca₅(PO₄)₃(F, Cl, OH) (repeating unit) and may include hydroxyapatite, fluorapatite, or admixtures thereof. The calcium precipitates may be separated (620) from the liquor.

The calcium and fluorine free liquor (640) may be processed to recover lithium values, for example undergoes lithium phosphate precipitation (650), using a source of phosphate, for example sodium phosphate (660). The resultant slurry (670) is subject to solid liquid separation (680), to produce a lithium phosphate product (690). The lithium free liquor (700) can then be recycled to the process as required.

The phosphate may be added as an aqueous solution to the lithium phosphate precipitation step (650). The phosphate may be selected from the group comprising phosphoric acid, potassium phosphate, sodium phosphate, or a combination thereof. It will be appreciated that the concentration of the aqueous phosphate solution will be practically limited by its solubility. For example, the concentration of an aqueous potassium phosphate solution may be from 100 g/L to 800 g/L. Phosphate may be added to the liquor in stoichiometric excess to ensure that soluble lithium remaining in solution is less than 100 mg/L and residual phosphate remaining in solution is greater than 500 mg/L, in particular 500 mg/L to 3000 mg/L.

In some embodiments, when the phosphate solution comprises phosphoric acid, hydroxide ions (e.g. KOH) may be concurrently added to the liquor in an amount sufficient to maintain the pH of said solution above a threshold pH where lithium phosphate may re-dissolve and raise the soluble lithium in solution to greater than 100 mg/L.

Adding phosphate to the liquor to precipitate lithium phosphate may be performed at a temperature ranging from 50° C. to below boiling point of the solution, in particular greater than 90° C.

The lithium phosphate precipitate (690) may be separated from solution by conventional separation techniques and washed in several stages. Suitable separation techniques include, but are not limited to, filtration, gravity separation, centrifugation, decantation and so forth. The lithium free liquor (700) may be recycled as required.

The separated lithium phosphate precipitate (690) may then be optionally dried and transported for sale. Alternatively, or additionally, in some embodiments the lithium phosphate precipitate may then be treated to re-precipitate lithium phosphate, thereby reducing the presence of impurities that originate from the mixed metal material/process liquor such as potassium, sodium and sulfur. This step comprises at least partially dissolving the lithium phosphate precipitate (690) in phosphoric acid to form di-lithium phosphate (Li₂HPO₄), according to Equations (1) and (2):

Li₃PO₄+2H₃PO₄→3LiH₂PO₄ (1)

2Li₃PO₄+H₃PO₄→3Li₂HPO₄ (2)

The inventors opine that although di-lithium phosphate is the dominant aqueous species and precipitates upon reaching saturation, it is thermodynamically unstable and quickly converts to lithium phosphate, thereby regenerating phosphoric acid.

In some embodiments, the lithium phosphate precipitate (690) may be mixed with phosphoric acid to produce a slurry having solids density in the range of 15-50% w/w, for example of 35-45% w/w. The amount of phosphoric acid required may be sub-stoichiometric with respect to the complete “dissolution” of the lithium phosphate precipitate as Li₂HPO₄. For example, the amount of phosphoric acid required may be in the range of 50 kg/t to 250 kg/t of lithium phosphate precipitate.

The step of re-precipitating lithium phosphate may be performed at ambient temperature or around 30° C. The dissolution and re-precipitation of lithium phosphate may be performed for a period of between 4 h to 24 h. A residence time of about 24 h may be beneficial to achieve the maximum rejection of impurities at lower stoichiometric additions of phosphoric acid.

Recovery of lithium as re-precipitated lithium phosphate may be greater than 95%. It will be appreciated that the amount of lithium phosphate remaining soluble in the liquor from the refining step may be dependent on the pH and solids content of the process stream. In one embodiment, the pH may be in a range of pH 4 to pH 6.5, in particular pH 5 to pH 6, for example about pH 5, 5.2, 5.4, 5.6, 5.8 or 6, and combinations thereof.

The re-precipitated lithium phosphate precipitate may be separated from solution by conventional separation techniques and washed in several stages. Suitable separation techniques include, but are not limited to, filtration, gravity separation, centrifugation, decantation and so forth. Potassium hydroxide may be subsequently added to the separated liquor to regenerate a potassium phosphate stream. At least part of the potassium phosphate stream may then be recycled for as the source of phosphate (660).

The dried, separated re-precipitated lithium phosphate may be stored and subsequently transported for sale, or used as a feedstock for other processes, for example treated with sulfuric acid to produce lithium sulfate.

Alternatively or additionally, in some embodiments, lithium phosphate and lithium sulfate may be recovered from the liquor (640) using the process described in PCT/AU2019/050540, the contents of which are incorporated herein by reference.

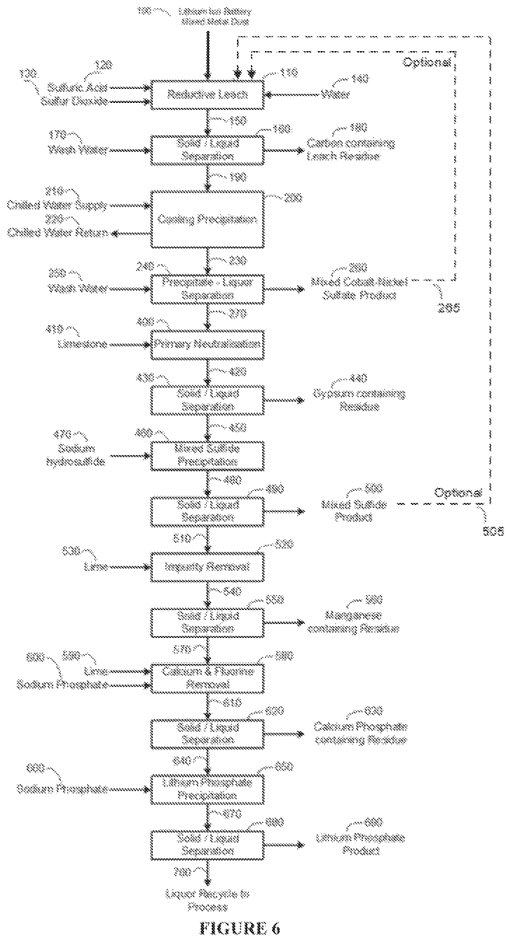

As a non-limiting example, referring to the embodiment of the process in FIG. 6, the separated mixed cobalt-nickel sulfate (260) and/or the mixed metal sulfide (500) can be partially recycled to the reductive leach (265 or 505). It will be appreciated that this will be beneficial to increasing and controlling concentrations of cobalt and nickel in the mixed metal sulfate liquor prior to mixed metal precipitation. Advantageously optionally recycling a portion of the mixed metal sulfide (505), may provide a source of reductant for the leach stage (110). It is also appreciated that other mixed metal intermediates such as hydroxides or carbonates could be recycled to the reductive leach stage.

The present application claims priority from AU2020902849 filed on 12 Aug. 2020, the entire contents of which are incorporated herein by reference.

### EXAMPLES

In order that the disclosure may be more clearly understood, particular embodiments of the invention are described in further detail below by reference to the following non-limiting experimental materials, methodologies and examples.

### Example 1: Cooling Precipitation

A mixed metal material (MMD) was obtained from recycled lithium-ion batteries. The elemental composition of the MMD is provided below in Table 2. The MMD was leached in sulfuric acid, with sulfur dioxide addition, at a temperature of 60° C., to produce a mixed metal sulfate process liquor. The conditions of the leach are outlined in Table 1:

TABLE 1
Reductive leach conditions

| SO₂ (Y/N) | Y |
|---|---|
| Leach temperature (° C.) | 60 |
| Initial solids (% w/w) | 29.5 |
| 98% H₂SO₄ addn. (kg/t) | 1589 |
| Final ORP (mV) | 508 |
| Terminal Free Acid (g/L) | 239 |
| Mass Loss in Leach (%) | 66 |

The mixed metal sulfate process liquor was separated from any leach residue and then progressively cooled to 5° C., with liquors sampled and assayed at intermediate temperatures. Final liquors and precipitate (e.g. crystals) were analysed and a mass balance was performed to determine the precipitation of major components.

The relevant assays, process liquor concentration, and extents of precipitation are shown in Table 2. Cobalt precipitation is 77%, and nickel 40%, for a combined average of 65% (cobalt plus nickel).

Aluminium, arsenic, cadmium, calcium, chromium, lithium, potassium, phosphorous, sodium, and silicon remain in solution. Copper, iron, magnesium, manganese, and zinc are partially rejected from the mixed sulfate precipitate. The precipitation profiles (% remaining in liquor) of the major elements in are displayed in FIG. 7.

TABLE 2
Cooling precipitation results

| | Mixed | Process Liquor | Precipitation temperature, ° C. | | | | | Mixed Cobalt- | |
|---|---|---|---|---|---|---|---|---|---|
| Element | Metal Dust | (60° C.) | 40 | 30 | 20 | 10 | 5 | Nickel Sulfate | Precipitation |
| Assay: | (% w/w) | (mg/L) | (mg/L) | (mg/L) | (mg/L) | (mg/L) | (mg/L) | (% w/w) | (%) |
| Al | 2.92 | 8686 | 8324 | 8155 | 8318 | 8944 | 9468 | 0.003 | — |
| As | 0.029 | 10 | 10 | 10 | 10 | 10 | 10 | 0.005 | — |
| Ca | 0.032 | 98 | 106 | 103 | 105 | 114 | 120 | 0.001 | — |
| Cd | 0.002 | 81 | 83 | 81 | 82 | 89 | 87 | 0.006 | 7 |
| Co | 13.8 | 45897 | 44678 | 45407 | 40888 | 24751 | 17446 | 22.18 | 77.1 |
| Cr | 0.009 | 13 | 15 | 15 | 15 | 16 | 17 | 0.005 | — |
| Cu | 1.85 | 6157 | 5725 | 5716 | 5643 | 5483 | 2230 | 2.40 | 62 |
| Fe | 0.81 | 2280 | 2228 | 2220 | 2217 | 2090 | 1910 | 0.320 | 27 |
| K | 0.042 | 793 | 583 | 570 | 585 | 634 | 675 | 0.001 | — |
| Li | 2.431 | 10001 | 9979 | 10060 | 10015 | 10742 | 11606 | 0.004 | 0.07 |
| Mg | 0.037 | 131 | 127 | 125 | 122 | 108 | 85 | 0.030 | 40.5 |
| Mn | 5.219 | 15621 | 14798 | 14970 | 14560 | 14547 | 12438 | 2.59 | 26.5 |
| Na | 0.058 | 204 | 155 | 153 | 163 | 176 | 188 | 0.001 | — |
| Ni | 6.778 | 21907 | 20923 | 21453 | 19237 | 12203 | 12908 | 5.53 | 40.3 |
| P | 0.385 | 1314 | 1220 | 1222 | 1277 | 1333 | 1394 | 0.012 | 1.5 |
| Pb | 0.003 | 100 | 50 | 50 | 50 | 50 | 50 | 0.050 | — |
| S | 0.228 | 155700 | 160991 | 161961 | 152228 | 143345 | 152416 | 16.92 | 17 |
| Si | 0.236 | 24 | 22 | 22 | 22 | 23 | 24 | 0.003 | — |
| Zn | 0.202 | 1244 | 1298 | 1277 | 1243 | 1004 | 821 | 0.319 | 41 |

### Example 2: Cooling Precipitation

The mixed metal dust (MMD) used in Example 1 was again was leached in sulfuric acid, with sulfur dioxide addition, at a temperature of 60° C., to produce a multi-element sulfate process liquor. The conditions of the leach are outlined in Table 3:

TABLE 3
Reductive leach conditions

| SO₂ (Y/N) | Y |
|---|---|
| Leach temperature (° C.) | 60 |
| Initial solids (% w/w) | 40 |
| 98% H₂SO₄ addn. (kg/t) | 1118 |
| Final ORP (mV) | 511 |
| Terminal Free Acid (g/L) | 187 |
| Mass Loss in Leach (%) | 64 |

The process liquor was separated from any leach residue and then progressively cooled to 5° C., with liquors sampled and assayed at intermediate temperatures. Final liquors and precipitates (e.g. crystals) were analysed and a mass balance was performed to determine the precipitation of major components.

The relevant assays, process liquor concentration, and extent of precipitation are shown in Table 4. Cobalt precipitation is 75%, and nickel 35%, for a combined average of 62% (cobalt plus nickel).

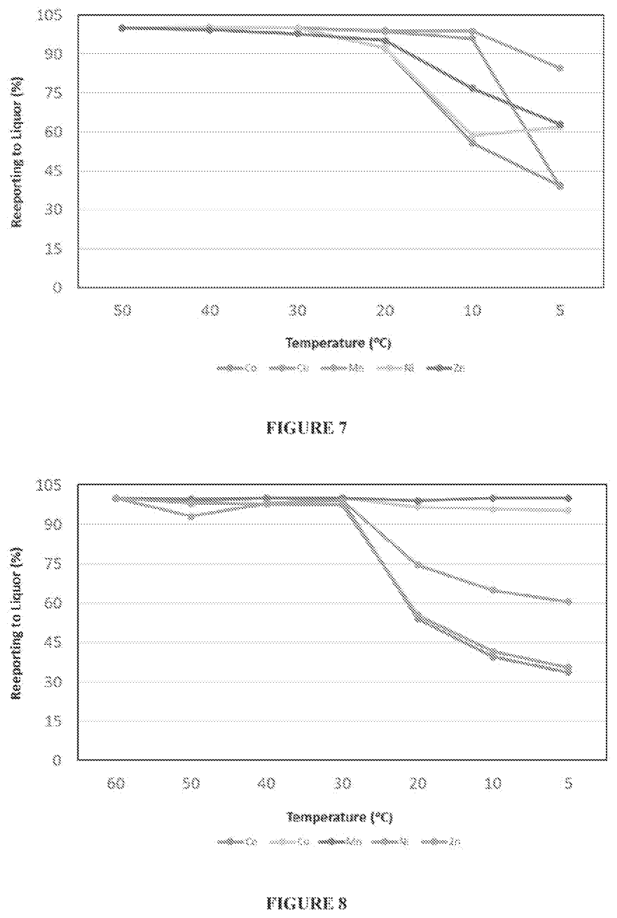

Aluminium, arsenic, cadmium, calcium, chromium, fluorine, lithium, potassium, phosphorous, sodium, and silicon remain in solution. Copper, iron, magnesium, manganese, and zinc are partially rejected from the mixed sulfate precipitate. The precipitation profiles (% remaining in liquor) of the major elements in are displayed in FIG. 8.

TABLE 4
Cooling precipitation results

| | Mixed | Process Liquor | Precipitation temperature, ° C. | | | | | Mixed Cobalt- | |
|---|---|---|---|---|---|---|---|---|---|
| Element | Metal Dust | (60° C.) | 40 | 30 | 20 | 10 | 5 | Nickel Sulfate | Precipitation |
| Assay: | (% w/w) | (mg/L) | (mg/L) | (mg/L) | (mg/L) | (mg/L) | (mg/L) | (% w/w) | (%) |
| Al | 2.92 | 12917 | 12993 | 12825 | 13864 | 14579 | 14780 | 0.011 | — |
| As | 0.029 | 10 | 10 | 10 | 10 | 10 | 10 | 0.0005 | — |
| Ca | 0.032 | 185 | 173 | 184 | 194 | 199 | 206 | 0.0005 | — |
| Cd | 0.002 | 107 | 101 | 105 | 113 | 113 | 115 | 0.002 | 3 |
| Co | 13.8 | 51893 | 53076 | 51453 | 28068 | 20476 | 17434 | 26.8 | 74.9 |
| Cr | 0.009 | 20 | 19 | 19 | 21 | 22 | 22 | 0.0005 | — |
| Cu | 1.85 | 7333 | 7525 | 7487 | 7088 | 7035 | 6990 | 0.567 | 16 |
| Fe | 0.81 | 2816 | 2710 | 2823 | 2763 | 2726 | 2708 | 0.166 | 12 |
| K | 0.042 | 852 | 816 | 826 | 903 | 932 | 942 | 0.001 | 0.2 |
| Li | 2.431 | 15263 | 15337 | 15236 | 16316 | 17146 | 17358 | 0.014 | 0.17 |
| Mg | 0.037 | 190 | 179 | 185 | 152 | 135 | 130 | 0.021 | 24.8 |
| Mn | 5.219 | 10019 | 10358 | 10270 | 9931 | 10026 | 10141 | 0.405 | 8.0 |
| Na | 0.058 | 226 | 225 | 222 | 242 | 262 | 262 | 0.0005 | — |
| Ni | 6.778 | 32288 | 31589 | 31470 | 17904 | 13431 | 11452 | 5.6 | 35.3 |
| P | 0.385 | 1997 | 1826 | 1819 | 1982 | 2141 | 2223 | 0.005 | 0.5 |
| Pb | 0.003 | 100 | 100 | 100 | 10 | 10 | 10 | 0.005 | — |
| S | 0.228 | 169446 | 169269 | 175177 | 155718 | 154622 | 153557 | 16.6 | 20 |
| Si | 0.236 | 20 | 19 | 19 | 20 | 20 | 21 | 0.002 | 8 |
| Zn | 0.202 | 1540 | 1509 | 1527 | 1148 | 999 | 932 | 0.172 | 23 |
| F | 1.201 | 6160 | 5930 | 5830 | 6560 | 6750 | 6720 | 0.006 | — |

### Example 3: Mixed Cobalt-Nickel Sulfate Re-Precipitation

The mixed cobalt-nickel sulfate precipitate produced in Example 2 was dissolved in water at 60° C., to produce a concentrated sulfate solution, which then underwent cooling to 5° C., resulting in production of purified mixed cobalt-nickel sulfate precipitate.

Relevant assays and extents of precipitation are shown in Table 5. Cobalt re-precipitation is 61%. Further purification is shown by inspection of the relative compositions of the mixed cobalt-nickel sulfate and the purified cobalt-nickel sulfate.

TABLE 5
Mixed cobalt-nickel sulfate re-precipitation

| | Mixed | Re- | Precipi- | Purified | |
|---|---|---|---|---|---|
| | Cobalt- | dissolved | tation | Cobalt- | |
| | Nickel | Liquor | Liquor | Nickel | Precipi- |
| Element | Sulfate | (60° C.) | (5° C.) | Sulfate | tation |
| Assay: | (% w/w) | (mg/L) | (mg/L) | (% w/w) | (%) |
| Al | 0.011 | 71 | 93 | 0.005 | — |
| As | 0.0005 | 10 | 10 | 0.0250 | — |
| Ca | 0.0005 | 1 | 2 | 0.0005 | — |
| Cd | 0.002 | | | 0.005 | — |
| Co | 26.8 | 166475 | 90775 | 28.9 | 61 |
| Cr | 0.0005 | 10 | 10 | 0.0025 | — |
| Cu | 0.567 | 3227 | 2227 | 0.452 | 44 |
| Fe | 0.166 | 880 | 501 | 0.159 | 58 |
| K | 0.001 | 1 | 1 | 0.000 | — |
| Li | 0.014 | 84 | 110 | 0.000 | 2.0 |
| Mg | 0.021 | 111 | 106 | 0.010 | 27.5 |
| Mn | 0.405 | 2285 | 2487 | 0.130 | 17.6 |
| Na | 0.0005 | 1 | 1 | 0.0005 | — |
| Ni | 5.6 | 31727 | 27531 | 3.45 | 34 |
| P | 0.005 | 500 | 500 | 0.050 | — |
| Pb | 0.005 | 100 | 100 | 0.050 | — |
| S | 16.6 | 101430 | 63662 | 17.4 | 58 |
| Si | 0.002 | 50 | 50 | 0.005 | — |
| Zn | 0.172 | 1072 | 1036 | 0.088 | 28 |
| F | 0.006 | — | — | — | — |

### Example 4: Mixed Cobalt-Nickel Sulfate Precipitation from Nickel Doped Metal Sulfate Process Liquors

The mixed metal dust (MMD) used in Example 1 and 2 was again leached in sulfuric acid, with sulfur dioxide addition, at a temperature of 60° C., to produce a multi-element sulfate process liquor. The conditions of the leach are outlined in Table 6:

TABLE 6
Reductive leach conditions

| SO₂ (Y/N) | Y |
|---|---|
| Leach temperature (° C.) | 60 |
| Initial solids (% w/w) | 29.3 |
| 98% H₂SO₄ addn. (kg/t) | 1085 |
| Final ORP (mV) | 540 |
| Terminal Free Acid (g/L) | 123 |
| Mass Loss in Leach (%) | 61 |

The process liquor was separated from any leach residue to obtain a process liquor. This process liquor had a nickel to cobalt ratio (Ni:Co) of approximately 1:2 (parent process liquor). Two fractions of the parent process liquor were then doped with NiSO₄.6H₂O at 60° C. to obtain a process liquor having a Ni:Co ratio of approximately 1:1 (low Ni doped process liquor) and a process liquor having a Ni:Co ratio of approximately 2:1 (high Ni doped process liquor). A comparison of the three process liquor compositions is shown in Table 7 (bolded figures are ‘less than’ values):

TABLE 7
Summary of process liquor composition

| | Parent process | Low Ni doped | High Ni doped |
|---|---|---|---|
| | liquor | process liquor | process liquor |
| Element | mg/l | mg/l | mg/l |
| Al | 9310 | 9137 | 8375 |
| As | 10 | 10 | 10 |
| Ca | 162 | 160 | 140 |
| Cd | 112 | 112 | 106 |
| Co | 48223 | 44022 | 37869 |
| Cr | 18 | 18 | 17 |
| Cu | 7123 | 6464 | 5658 |
| Fe | 2311 | 2239 | 2109 |
| K | 558 | 567 | 489 |
| Li | 11364 | 10116 | 8922 |
| Mg | 126 | 122 | 106 |
| Mn | 17270 | 15516 | 13296 |
| Na | 173 | 180 | 154 |
| Ni | 27803 | 53972 | 64129 |
| P | 1218 | 1222 | 1134 |
| Pb | 100 | 100 | 100 |
| S | 135486 | 136764 | 127583 |
| Si | 50 | 43 | 38 |
| Zn | 1488 | 1439 | 1337 |

The process liquors outlined in Table 7 were progressively cooled to from 60° C. to 5° C., with liquors sampled and assayed at intermediate temperatures. Final liquors and precipitates (e.g. crystals) were analysed and a mass balance was performed to determine the precipitation of major components. The relevant assays, process liquor concentration and extent of precipitation are shown in Table 8. Cobalt precipitation ranged from 57 to 71%, and nickel precipitation ranged from 47 to 60%.

TABLE 8
Cooling precipitation results of the process liquors at 5° C.

| | Feed Liquor | | | | | | | | | | | |
|---|---|---|---|---|---|---|---|---|---|---|---|---|
| | Parent | | | | Low Ni | | | | High Ni | | | |
| | Final Temp (° C.) | | | | | | | | | | | |
| | 5 | | | | 5 | | | | 5 | | | |
| | Initial | PF | Residue | Precip. | Initial | PF | Residue | Precip. | Initial | PF | Residue | Precip. |
| Element | (mg/L) | (mg/L) | (wt %) | (%) | (mg/L) | (mg/L) | (wt %) | (%) | (mg/L) | (mg/L) | (wt %) | (%) |
| Al | 9310 | 10376 | 0.004 | — | 9137 | 10656 | 0.005 | — | 8375 | 9142 | 0.002 | — |
| Co | 48223 | 20739 | 16.2 | 63 | 44022 | 15840 | 11.7 | 71 | 37869 | 19861 | 6.8 | 57 |
| Cu | 7123 | 3568 | 1.9 | 57 | 6464 | 1872 | 1.9 | 76 | 5658 | 3743 | 0.450 | 46 |
| Li | 11364 | 12345 | 0.005 | 0.1 | 10116 | 12489 | 0.006 | 0.1 | 8922 | 10518 | 0.003 | 0.1 |
| Mg | 126 | 105 | 0.022 | 28 | 122 | 84 | 0.020 | 44 | 106 | 68 | 0.020 | 47 |
| Mn | 17270 | 15697 | 1.5 | 22 | 15516 | 13495 | 1.6 | 29 | 13296 | 12832 | 0.832 | 21 |
| Ni | 27803 | 17083 | 5.2 | 47 | 53972 | 32888 | 9.3 | 50 | 64129 | 31409 | 14.8 | 60 |
| S | 135486 | 118346 | 12.6 | 25 | 136764 | 122704 | 12.5 | 27 | 127583 | 109735 | 11.8 | 30 |
| Zn | 1488 | 1206 | 0.262 | 30 | 1439 | 962 | 0.229 | 45 | 1337 | 820 | 0.208 | 50 |

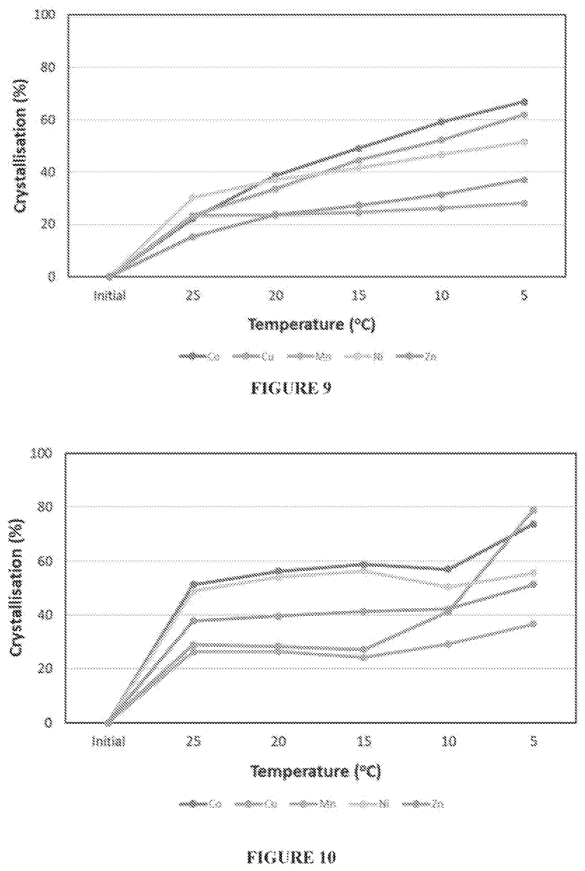

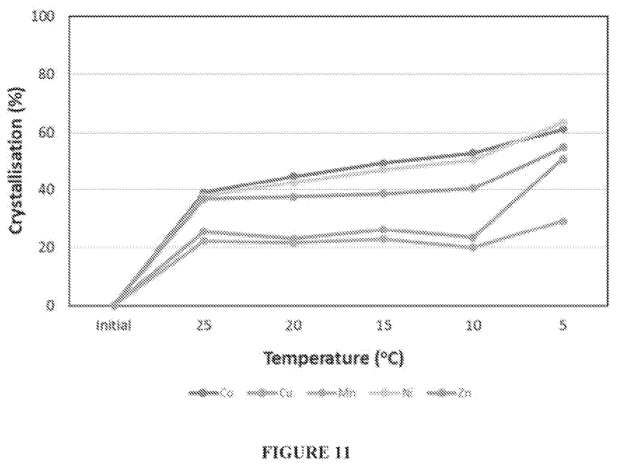

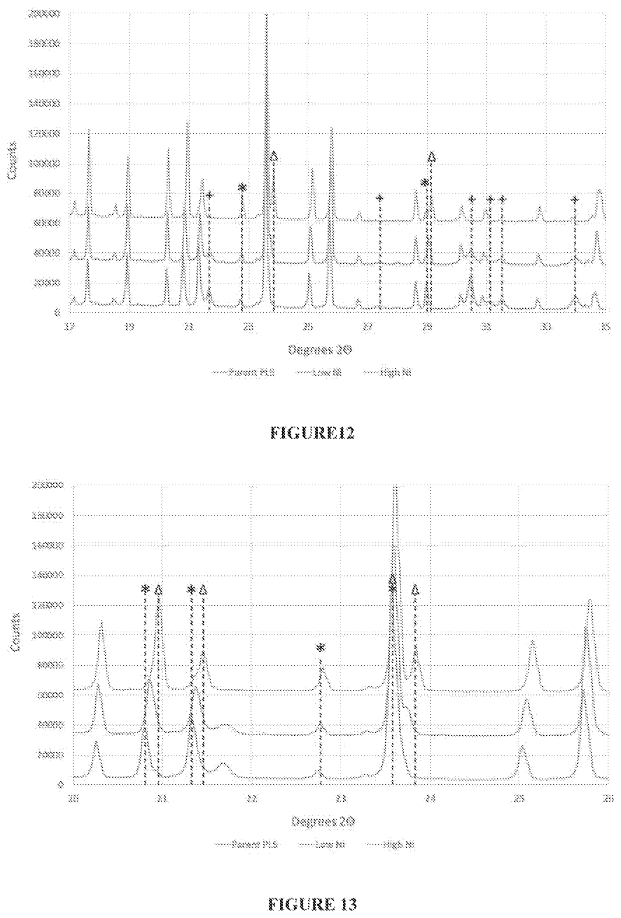

The precipitation profiles (% amount of the metal in the precipitate at a selected temperature) of the major metals (Co, Ni, Cu, Mn and Zn) are displayed in FIGS. 9, 10, and 11 for the parent, low Ni doped, and high Ni doped process liquors, respectively. Notably, the precipitation profile of the high Ni doped process liquor was comparable to the precipitation profile of the parent process liquor in both order and magnitude.

A comparison of the cooling precipitation solid assays for the three process liquors is shown in Table 9, where bolded figures are ‘less than’ values:

TABLE 9
Comparison of cooling precipitation assays

| Feed Liquor | Parent | Low Ni | High Ni |
|---|---|---|---|
| Ni/Co Ratio in Feed | 0.6 | 1.2 | 1.7 |
| Ni/Co Ratio in PF | 0.8 | 2.1 | 1.6 |
| Ni/Co Ratio in Res | 0.3 | 0.8 | 2.2 |

| Element | (wt %) | (wt %) | (wt %) |
|---|---|---|---|
| Al | 0.004 | 0.005 | 0.002 |
| As | 0.002 | 0.002 | 0.002 |
| Ca | 0.002 | 0.002 | 0.002 |
| Cd | 0.004 | 0.005 | 0.003 |
| Co | 16.2 | 11.7 | 6.8 |
| Cr | 0.002 | 0.002 | 0.002 |
| Cu | 1.95 | 1.9 | 0.45 |
| Fe | 0.045 | 0.033 | 0.013 |
| K | 0.002 | 0.002 | 0.002 |
| Li | 0.005 | 0.006 | 0.003 |
| Mg | 0.022 | 0.020 | 0.020 |
| Mn | 1.53 | 1.6 | 0.83 |
| Na | 0.002 | 0.002 | 0.002 |
| Ni | 5.2 | 9.3 | 14.8 |
| P | 0.002 | 0.002 | 0.002 |
| Pb | 0.025 | 0.024 | 0.023 |
| S | 12.6 | 12.5 | 11.8 |
| Si | 0.012 | 0.012 | 0.011 |
| Zn | 0.26 | 0.23 | 0.21 |

Table 9 shows that the rejection of impurities was significant for all process liquors. The majority of impurities in each of the resultant precipitation solids were below the detection limits of the solid assays. In particular, aluminium, cadmium, iron, lithium, and magnesium were observed in only trace/minor concentrations in each of the resultant cooling precipitation solids.

### Example 6: XRD Analysis of Precipitation Solids from Example 5

X-ray Diffraction (XRD) was undertaken on each of the three precipitation solids from Example 5 to identify the crystalline phases present in each. For each precipitation solid, a sub-sample was homogenised using a mortar and pestle, and approximately 1 g of material was pressed into an aluminium sample holder. The XRD analysis was run on a Bruker D8 X-Ray Diffractometer using CoKα radiation at 35 kV and 40 mA. Step scans were undertaken from 6 to 110° 2θ, with a step interval of 0.02° 2θ. Mineral identification was performed using X'Pert Highscore search/match software. A summary of the XRD results is presented in FIGS. 12 and 13.

The position and intensity of the reflections characteristic of CoSO₄.6H₂O (PDF 01-073-1446) and NiSO₄.6H₂O (PDF 00-026-1288) correlate with the change in the Co:Ni ratio in the feed process liquors. In particular, a consistent shift of many reflections to increasing two theta values with the increase in nickel concentration in the feed process liquor was observed. This shift indicates the presence of a crystalline mixed (Co/Ni)SO₄.6H₂O phase with a structure (space group) similar to NiSO₄.6H₂O, as opposed to a precipitate solid consisting of solely discrete sulfate compounds (e.g. cobalt sulfate and nickel sulfate).

Despite the presence of impurities, such as copper, manganese and zinc, in the precipitation profiles, no discrete crystalline phases of these impurities was identified.

Examples 5 and 6 demonstrate that a mixed cobalt-nickel sulfate can be crystallised directly from MMD leach liquors having varying ratios of Co:Ni consistent with that expected to be generated from different lithium-ion battery chemistries, whilst retaining good impurity rejection.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A process for recovering a mixed cobalt-nickel sulfate from a mixed metal sulfate process liquor produced by a reductive sulfuric acid leach of a mixed metal oxide dust (MMD) obtained from lithium-ion batteries, the process comprising the steps of:
a) cooling a mixed metal sulfate process liquor comprising at least cobalt and nickel and having a pH of less than about 4 from an initial temperature wherein the cobalt and nickel is dissolved therein to a temperature effective to precipitate out a mixed cobalt-nickel sulfate from the process liquor;
b) separating the mixed cobalt-nickel sulfate precipitate from the process liquor and producing a cobalt and nickel depleted liquor; and
c) optionally recycling at least part of the cobalt and nickel depleted liquor for use in the reductive sulfuric acid leach of the mixed metal oxide dust (MMD).

2. The process according to claim 1, wherein the mixed metal sulfate process liquor is cooled to a temperature selected from:
between about 0.1° C. to about 50° C.;
less than about 10° C.; and
about 5° C.

3-4. (canceled)

5. The process according to claim 1, wherein the initial temperature of the mixed metal sulfate process liquor is between about 30° C. to about 100° C.

6. The process according to claim 1, wherein the temperature differential between the initial temperature and cooled temperature of the mixed metal sulfate process liquor is selected from:
between about 20° C. to about 80° C.; and
between about 40° C. to about 60° C.

7. (canceled)

8. The process according to claim 1, wherein the mixed metal sulfate process liquor is cooled from the initial temperature at a rate of between about −1° C./min to about −50° C./min.

9. (canceled)

10. The process according to claim 1, wherein the mixed cobalt-nickel sulfate precipitate comprises between about 1% w/w to about 60% w/w cobalt and between about 1% w/w and 60% w/w nickel.

11. The process according to claim 1, wherein:
the recovery of cobalt from the mixed metal sulfate process liquor in the mixed cobalt-nickel sulfate precipitate is at least about 30% based on the total amount of cobalt in the process liquor, and/or
the recovery of nickel from the mixed metal sulfate process liquor in the mixed cobalt-nickel sulfate precipitate is at least about 30% based on the total amount of nickel in the process liquor.

12. (canceled)

13. The process according to claim 1, further comprising the steps of:
c) dissolving the separated mixed cobalt-nickel sulfate precipitate in an aqueous solution to form a mixed cobalt-nickel sulfate solution;
d) cooling the mixed cobalt-nickel sulfate solution from an initial temperature wherein the mixed cobalt-nickel sulfate is dissolved therein to a temperature effective to re-precipitate the mixed cobalt-nickel sulfate; and
e) separating the re-precipitated mixed cobalt-nickel sulfate from the solution.

14. The process according to claim 1, wherein the mixed metal sulfate process liquor has a free sulfuric acid concentration selected from:
greater than about 50 g/L based on the total volume of the process liquor; and
between about 50 g/L to about 300 g/L based on the total volume of the process liquor.

15. (canceled)

16. The process according to claim 1, wherein:
the concentration of cobalt in the mixed metal sulfate process liquor is between about 10 g/L to about 70 g/L based on the total volume of the process liquor; and/or
the concentration of aluminium in the mixed metal sulfate process liquor is between about 0.01 g/L to about 50 g/L based on the total volume of process liquor; and/or
the concentration of nickel in the mixed metal sulfate process liquor is between about 10 g/L to about 70 g/L based on the total volume of the process liquor.

17. (canceled)

18. The process according to claim 1, wherein the mixed metal sulfate process liquor is formed by the step a1) of heating a slurry comprising mixed metal oxide dust (MMD), a reductant, and sulfuric acid to produce a process slurry comprising the mixed metal sulfate process liquor.

19. The process according to claim 18, wherein the slurry is heated to a temperature from about 50° C. up to the boiling point of the slurry.

20. (canceled)

21. The process according to claim 18, wherein the slurry is heated for a period of time of between about 2 h to 24 h.

22. (canceled)

23. The process according to claim 18, wherein the slurry has a solids density selected from:
between about 20% w/w to about 60% w/w based on the total weight of the slurry, and
between about 40% w/w to about 50% w/w based on the total weight of the slurry.

24. (canceled)

25. The process according to claim 18, wherein the reductant is provided in the slurry in an amount effective to provide an oxidation reduction potential (ORP) of between about 300 mV to about 700 mV.

26. The process according to claim 18, wherein the reductant comprises sulfur dioxide or hydrogen peroxide.

27. The process according to claim 18, wherein the amount of sulfuric acid in the slurry is selected from:
between about 100 kg/t to about 5000 kg/t based on the total weight of the mixed metal material, and
between about 800 kg/t to about 3000 kg/t based on the total weight of the mixed metal material.

28-30. (canceled)

31. The process according to claim 1, wherein the mixed metal oxide dust comprises lithium nickel manganese cobalt oxide (NMC), lithium cobalt oxide (LCO) or lithium nickel cobalt aluminium oxide (NCA), lithium manganese oxide (LMO), lithium ferro phosphate (LFP) or a mixture thereof.

32. (canceled)

33. The process according to claim 1, wherein the mixed metal sulfate process liquor has a pH of between about −1 to about 3.
